(19) United States
(12) Patent Application Publication
(10) Pub. No.: US 2009/0106571 A1
(43) Pub. Date: Apr. 23, 2009

(54) Systems and Methods to Adaptively Load Balance User Sessions to Reduce Energy Consumption

(76) Inventors: Anthony Low, St. Ives (AU); Anil Roychoudhry, Woodcroft (AU); Huai Chiun Chin, Glenwood (AU)

Correspondence Address: CHOATE, HALL & STEWART / CITRIX SYSTEMS, INC., TWO INTERNATIONAL PLACE, BOSTON, MA, 02110, US

(21) Appl. No.: 12/255,197

(22) Filed: Oct. 21, 2008

Related U.S. Application Data
(60) Provisional application No. 60/981,510, filed on Oct. 21, 2007.

(51) Int. Cl. G06F 1/00; G06F 15/16

(52) U.S. Cl. 713/310; 709/224; 713/340

(57) ABSTRACT

A method for adaptively load balancing user sessions to reduce energy consumption includes identifying a session type for each of a plurality of user sessions. A server group is defined, providing access to a subset of the user sessions having a common session type. A power management schedule is also defined for the server group. The method includes consolidating, onto at least one server in the server group, the subset of user sessions. In still another aspect, a method for reducing energy consumption by dynamically managing power modes for a plurality of servers, includes monitoring, via a power monitoring agent, a level of load on one of the servers. A power management console generates a power management schedule for a server, responsive to the monitored level of load. Responsive to the power management schedule, a power management controller dynamically controls a level of power for the server.

### RELATED APPLICATIONS

The present application claims priority to U.S. Provisional Patent Application Ser. No. 60/981,510, entitled “Systems And Methods To Adaptively Load Balance User Sessions To Reduce Energy Consumption” filed Oct. 21, 2007, which is incorporated herein by reference.

### FIELD OF THE DISCLOSURE

This disclosure generally relates to systems and methods to load balance user sessions. In particular, this disclosure relates to systems and methods to adaptively load balance user sessions to reduce energy consumption.

### BACKGROUND OF THE DISCLOSURE

In a conventional computing system environment comprising a plurality of servers, such as in a typical server farm environment, each active member of the plurality of servers consumes electricity and can generate significant amounts of heat. In general, there will be periods of reduced activities on at least some of the plurality of servers, for example, during non-business hours. Even during business hours, it is typically the case that not all servers in the server farm will be operating at their full capacity and that there is potential for improved energy management. However, conventional systems include servers which are operational twenty-four hours a day and seven days a week, leading to inefficient, expensive or wasteful use of energy. Furthermore, some conventional systems provide load balancing rules which may result in the use of more servers than necessary, in the interest of improving perceptions of responsiveness. These systems may lack dynamic, flexible rules that evaluate actual usage patterns and generate power management schedules accordingly.

### BRIEF SUMMARY OF THE DISCLOSURE

In one aspect, a method for adaptively load balancing user sessions to reduce energy consumption includes identifying a session type for each of a plurality of user sessions. The method includes defining a server group providing access to a subset of the plurality of user sessions having a common session type. The method includes defining a power management schedule for the server group. The method includes consolidating, onto at least one server in the server group, the subset of the plurality of user sessions. In one embodiment, the method includes receiving, from a power management agent, information identifying a session type for at least one of the plurality of user sessions. In another embodiment, the method includes defining a server group including at least one server substantially optimized to provide user sessions of the common session type. In another embodiment, the method includes monitoring, by a power management agent, a change in a level of load.

In one embodiment, the method includes dynamically modifying the power management schedule for the server group, responsive to a change in a level of load. In another embodiment, the method includes dynamically allocating an available resource within the server group. In still another embodiment, the method includes relocating at least one of the subset of the plurality of user sessions from a first server in the server group to a second server in the server group. In yet another embodiment, the method includes powering down the first server in the server group.

In another aspect, a system for adaptively load balancing user sessions to reduce energy consumption includes a power management console. The power management console identifies a session type for each of a plurality of user sessions. The power management console defines a server group providing access to a subset of the plurality of user sessions having a common session type. The power management console defines a power management schedule for the server group. The system includes a power management controller consolidating, onto at least one server in the server group, the subset of the plurality of user sessions.

In one embodiment, the power management console includes an interface for identifying a level of load associated with the identified session type. In another embodiment, the power management console includes an interface for identifying a session type for an application session. In still another embodiment, the power management console includes an interface for identifying a session type for a desktop session. In yet another embodiment, the power management console includes an interface for identifying a session type for a connection to a virtual machine. In still even another embodiment, the power management console includes an interface for defining a server group including at least one server substantially optimized to provide user sessions of a common session type.

In one embodiment, the system includes a power monitoring agent, in communication with the power management console and the power management controller. In another embodiment, the power monitoring agent provides information for identifying a session type for at least one of the plurality of user sessions, and monitors a change in a level of load. In still another embodiment, the power management console automatically defines the power management schedule for the server group, responsive to identifying a session type for each of the plurality of user sessions. In still even another embodiment, the power management console automatically defines the power management schedule for the server group, responsive to defining the server group providing access to the subset of the plurality of user sessions having a common session type. In yet another embodiment, the power management console dynamically changes the power management schedule for the server group, responsive to a change in a level of load on at least one server in the server group.

In one embodiment, the power management controller dynamically changes the power management schedule for the server group, responsive to a change in a level of load on at least one server in the server group. In another embodiment, the power management controller dynamically allocates an available resource within the server group. In still another embodiment, the power management controller relocates at least one of the subset of the plurality of user sessions from a first server in the server group to a second server in the server group. In still even another embodiment, the power management controller includes a transmitter sending a command to the power management agent to power down the first server in the server group. In yet another embodiment, the power management controller directs the power management agent to place the first server in the server group in a low power state.

In still another aspect, a method for reducing energy consumption by dynamically managing power modes for a plurality of servers, includes monitoring, via a power monitoring agent, a level of load on one of a plurality of servers. The method includes generating, by a power management console, a power management schedule for a server in the plurality of servers, responsive to the monitored level of load. The method includes dynamically controlling, by a power management controller, a level of power for the server, responsive to the power management schedule. In one embodiment, the method includes dynamically generating, by the power management console, the power management schedule for a server in the plurality of servers, responsive to the monitored level of load.

In one embodiment, the method includes dynamically modifying, by the power management controller, the power management schedule for a server in the plurality of servers, responsive to the monitored level of load. In another embodiment, the method includes dynamically controlling a level of power by powering up one of a plurality of servers. In still another embodiment, the method includes dynamically controlling a level of power by powering down one of a plurality of servers.

In yet another aspect, a system for reducing energy consumption by dynamically managing power modes for a plurality of servers includes a power management agent monitoring a level of load on one of the plurality of servers. The system includes a power management console, in communication with the power management agent, defining a power management schedule for the one of the plurality of servers, the power management schedule generated responsive to the monitored level of load. The system includes a power management controller, in communication with the power management console and the power management agent, dynamically controlling a level of power to the one of the plurality of servers, responsive to the power management schedule.

In one embodiment, the power management agent executes on one of the plurality of servers. In another embodiment, the power management console includes an interface displaying the monitored level of load on one of the plurality of servers. In still another embodiment, the power management console includes an interface receiving a power management schedule from a user. In yet another embodiment, the power management console dynamically generates the power management schedule for the one of the plurality of servers, responsive to the monitored level of load.

In one embodiment, the power management controller dynamically modifies the power management schedule for the one of the plurality of servers, responsive to the monitored level of load. In another embodiment, the power management controller controls one of a plurality of levels of power for the one of the plurality of servers, the plurality of levels of power including a powered-down level. In still another embodiment, the power management controller controls one of a plurality of levels of power for the one of the plurality of servers, the plurality of levels of power including a low-power level. In yet another embodiment, the power management controller controls one of a plurality of levels of power for the one of the plurality of servers, the plurality of levels of power including an intermediate-power level. In still even another embodiment, the power management controller controls one of a plurality of levels of power for the one of the plurality of servers, the plurality of levels of power including a high-power level.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 1D is a block diagram depicting an embodiment of a network environment for delivering and/or operating a computing environment on a client;

FIG. 1E is a block diagram depicting an embodiment of a client;

FIGS. 1F and 1G are block diagrams depicting embodiments of an appliance in a network environment;

FIG. 1H is a block diagram depicting an embodiment of an appliance using a plurality of monitoring agents to monitor a network service;

FIG. 2 is a block diagram depicting an embodiment of a system to adaptively load balance user sessions, and dynamically manage power modes for a plurality of servers, to reduce energy consumption;

FIG. 3 is a flow diagram depicting one embodiment of the steps taken in a method to adaptively load balance user sessions to reduce energy consumption;

FIG. 4 is a flow diagram depicting one embodiment of the steps taken in a method for reducing energy consumption by dynamically managing power modes for a plurality of servers;

FIG. 5A is a block diagram depicting an embodiment a system to adaptively load balance user sessions, and dynamically manage power modes for a plurality of presentation servers, to reduce energy consumption;

FIGS. 5B and 5C are charts depicting embodiments of a plurality of user sessions before and after consolidation into server groups in connection with the methods and systems described herein;

FIGS. 6A and 6B are block diagrams depicting embodiments of a system for power metering and reporting;

FIGS. 7A and 7B are block diagrams depicting embodiments of a system for controlling server consolidation to reduce power consumption; and

FIG. 8 is a block diagram depicting an embodiment of a system for reducing energy consumption in a plurality of servers.

### DETAILED DESCRIPTION

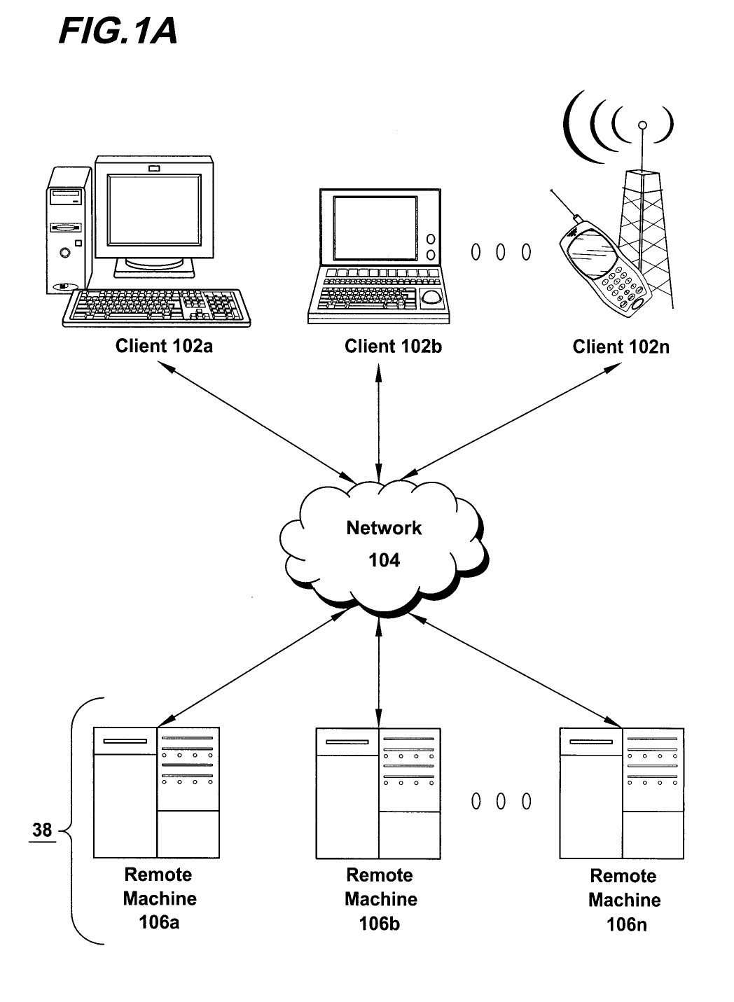

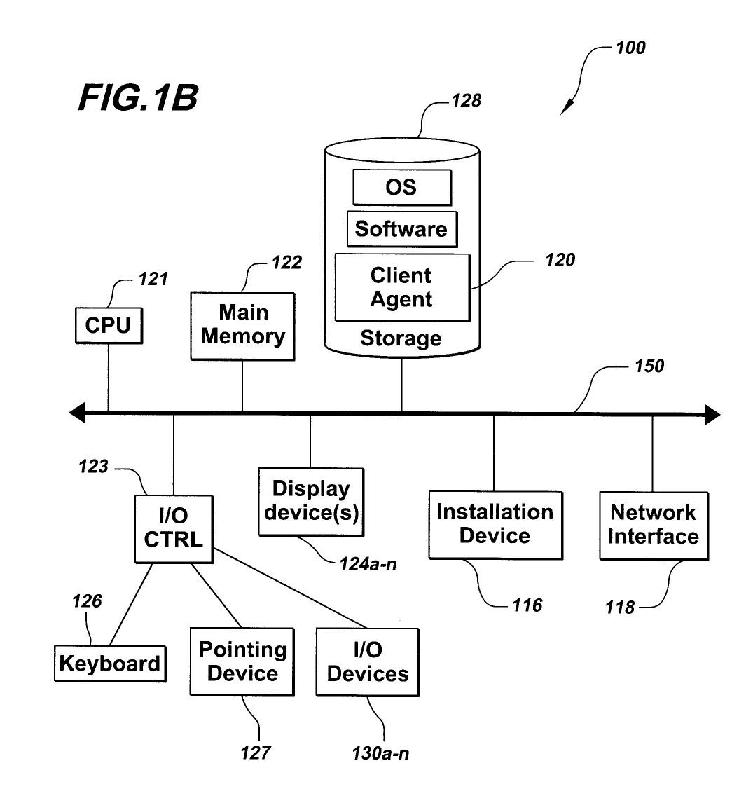

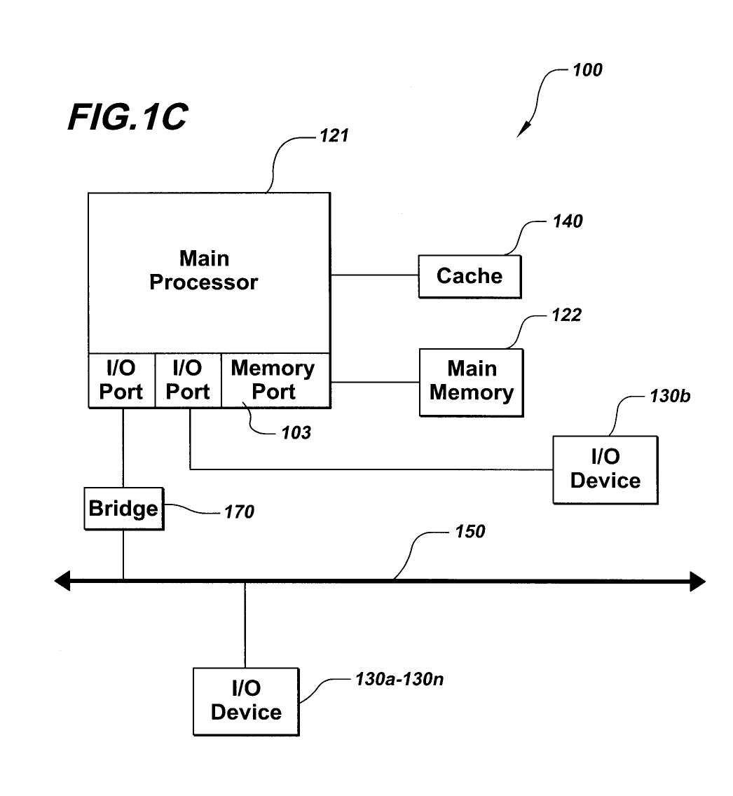

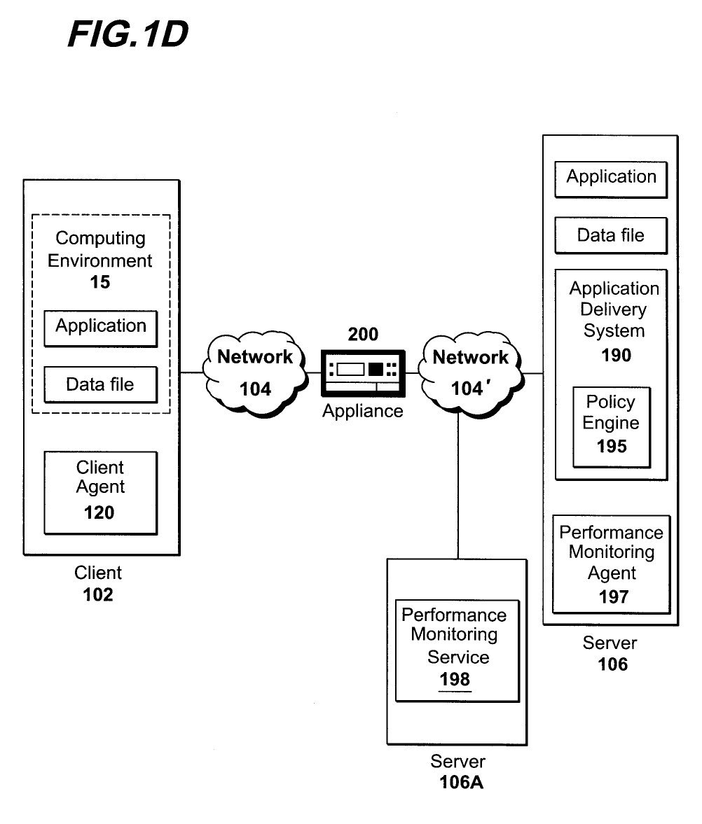

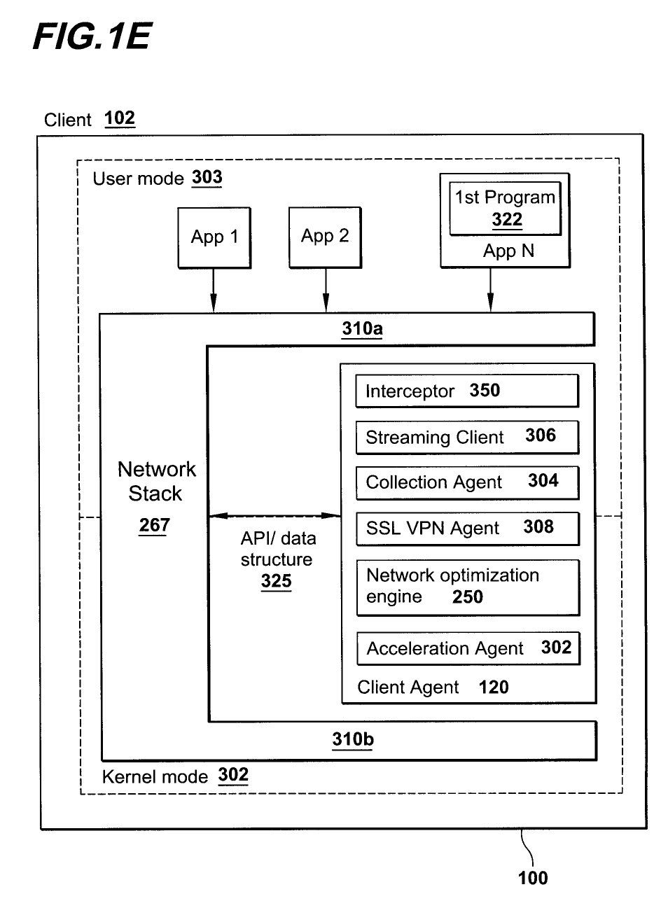

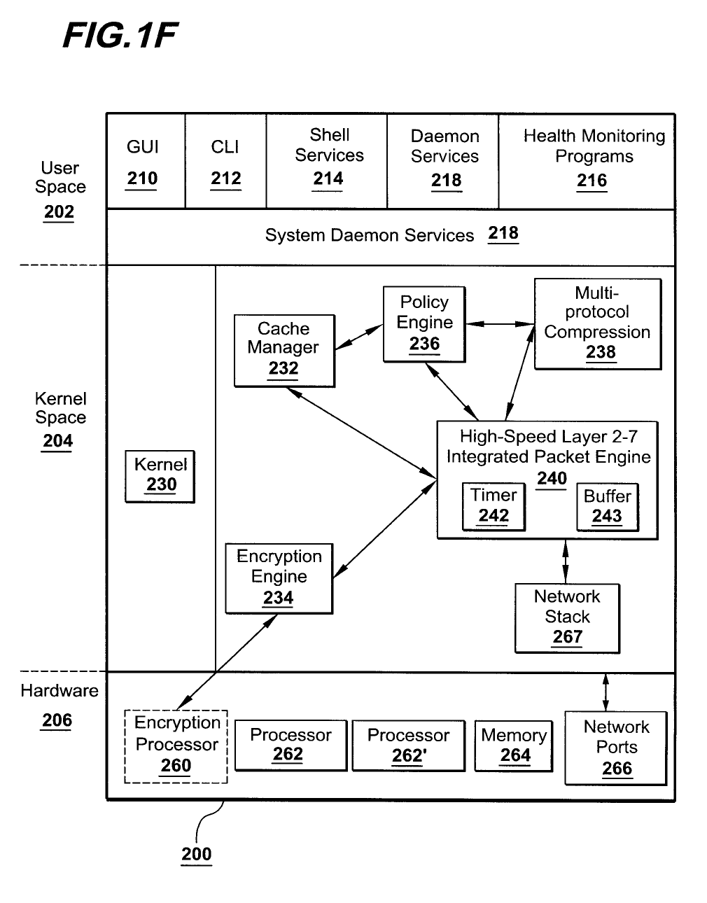

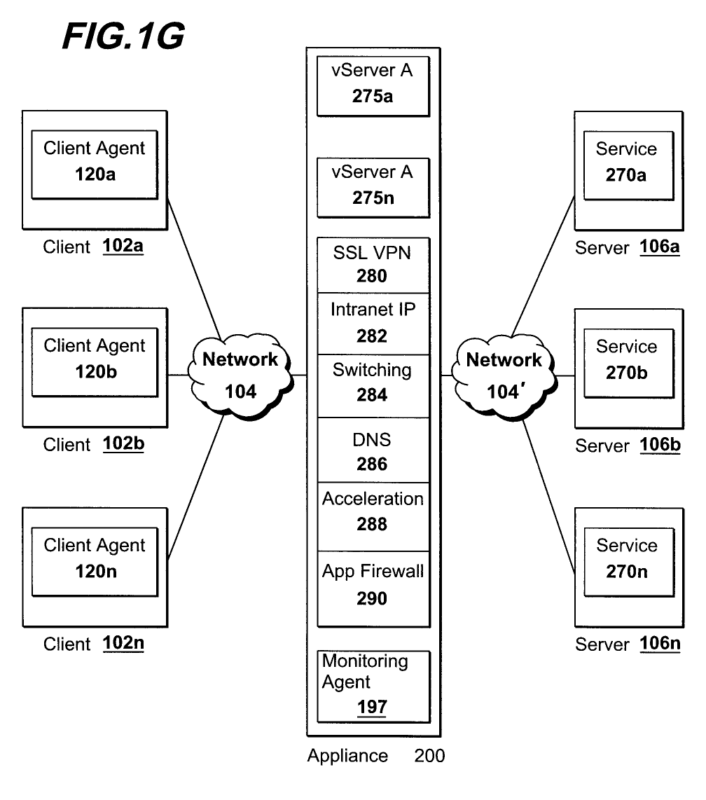

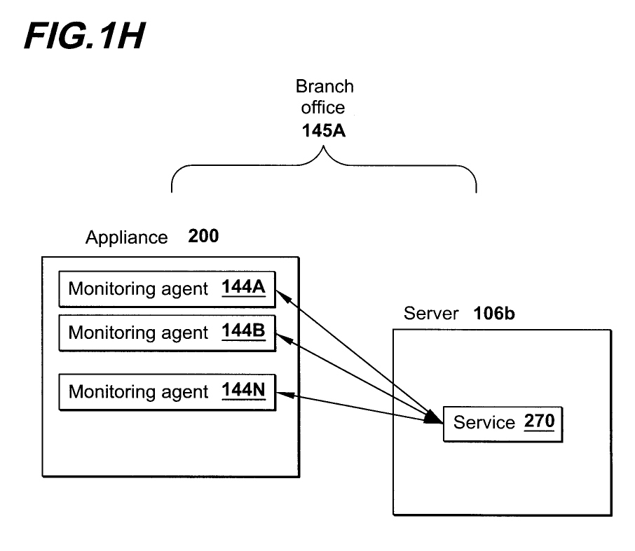

Referring now to FIG. 1A, an embodiment of a network environment is depicted. In brief overview, the network environment includes one or more clients 102a-102n (also generally referred to as local machine(s) 102, node(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106 or remote machine(s) 106) via one or more networks 104. In some embodiments, a client 102 has the capacity to function as both a client node 102 seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a server farm 38 may be administered as a single entity. In still other embodiments, the server farm 38 includes a plurality of server farms 38. The servers 106 within each server farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the server farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each server farm 38 do not need to be physically proximate to another server 106 in the same server farm 38. Thus, the group of servers 106 logically grouped as a server farm 38 may be interconnected using a wide-area network (WAN) connection or a metropolitan-area network (MAN) connection. For example, a server farm 38 may include servers 106 physically located in different continents or different regions of a continent, country, state, city, campus, or room. Data transmission speeds between servers 106 in the server farm 38 can be increased if the servers 106 are connected using a local-area network (LAN) connection or some form of direct connection. Additionally, a heterogeneous server farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif., the Xen hypervisor, an open source product whose development is overseen by Citrix Systems, Inc., the VirtualServer or virtual PC hypervisors provided by Microsoft, or others.

In order to manage a server farm 38, at least one aspect of the performance of servers 106 in the server farm 38 should be monitored. Typically, the load placed on each server 106 or the status of sessions running on each server 106 is monitored. In some embodiments, a centralized service may provide management for server farm 38. The centralized service may gather and store information about a plurality of servers 106, respond to requests for access to resources hosted by servers 106, and enable the establishment of connections between client machines 102 and servers 106.

Alternatively, management of the server farm 38 may be de-centralized. For example, one or more servers 106 may comprise components, subsystems and modules to support one or more management services for the server farm 38. In one of these embodiments, one or more servers 106 provide functionality for management of dynamic data, including techniques for handling failover, data replication, and increasing the robustness of the server farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In some embodiments, a server 106 provides a remote authentication dial-in user service, and is referred to as a RADIUS server. In other embodiments, a server 106 may have the capacity to function as either an application server or as a master application server. In still other embodiments, a server 106 is a blade server. In yet other embodiments, a server 106 executes a virtual machine providing, to a user or client computer 102, access to a computing environment.

In some embodiments, a hypervisor executes on a server 106 executing an operating system. In one of these embodiments, a server 106 executing an operating system and a hypervisor may be said to have a host operating system (the operating system executing on the machine), and a guest operating system (an operating system executing within a computing resource partition provided by the hypervisor). In other embodiments, a hypervisor interacts directly with hardware on a server 106, instead of executing on a host operating system. In one of these embodiments, the hypervisor may be said to be executing on “bare metal,” referring to the hardware comprising the server 106.

In one embodiment, a server 106 may include an active directory. The server 106 may be an application acceleration appliance. For embodiments in which the server 106 is an application acceleration appliance, the server 106 may provide functionality including firewall functionality, application firewall functionality, or load balancing functionality. In some embodiments, the server 106 includes an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

In some embodiments, a server 106 executes an application on behalf of a user of a client 102. In other embodiments, a server 106 executes a virtual machine, which provides an execution session within which applications execute on behalf of a user or a client 102. In one of these embodiments, the execution session is a hosted desktop session. In another of these embodiments, the execution session provides access to a computing environment, which may comprise one or more of: an application, a plurality of applications, a desktop application, and a desktop session in which one or more applications may execute.

In one embodiment, the server 106 provides the functionality of a web server. In another embodiment, the server 106a receives requests from the client 102, forwards the requests to a second server 106b and responds to the request by the client 102 with a response to the request from the second server 106b. In still another embodiment, a server 106 acquires an enumeration of applications available to the client 102 and address information associated with a server 106′ hosting an application identified by the enumeration of applications. In yet another embodiment, the server 106 presents a response to the request to the client 102 using a web interface. In one embodiment, the client 102 communicates directly with the server 106 to access the identified application. In another embodiment, the client 102 receives output data, such as display data, generated by an execution of the identified application on the server 106.

In some embodiments, the server 106 or a server farm 38 may be running one or more applications, such as an application providing a thin-client computing or remote display presentation application. In one embodiment, the server 106 or server farm 38 executes as an application any portion of the CITRIX ACCESS SUITE by Citrix Systems, Inc., such as the METAFRAME, CITRIX PRESENTATION SERVER, CITRIX XENAPP, CITRIX XEN DESKTOP and/or any of the MICROSOFT WINDOWS Terminal Services manufactured by the Microsoft Corporation. In another embodiment, the application is an ICA client, developed by Citrix Systems, Inc., of Fort Lauderdale, Fla. In still another embodiment, the server 106 may run an application, which, for example, may be an application server providing email services such as MICROSOFT EXCHANGE manufactured by the Microsoft Corporation of Redmond, Wash., a web or Internet server, or a desktop sharing server, or a collaboration server. In yet another embodiment, any of the applications may comprise any type of hosted service or products, such as GOTOMEETING provided by Citrix Online Division, Inc. of Santa Barbara, Calif., WEBEX provided by WebEx, Inc., of Santa Clara, Calif., or Microsoft Office LIVE MEETING provided by Microsoft Corporation of Redmond, Wash.

A client 102 may execute, operate or otherwise provide an application, which can be any type or form of software, program, or executable instructions such as any type and/or form of web browser, web-based client, client-server application, a thin-client computing client, an ActiveX control, or a JAVA applet, or any other type and/or form of executable instructions capable of executing on client 102. In some embodiments, the application may be a server-based or a remote-based application executed on behalf of the client 102 on a server 106. In one embodiment, the server 106 may display output to the client 102 using any thin-client or remote-display protocol, such as the Independent Computing Architecture (ICA) protocol manufactured by Citrix Systems, Inc., of Ft. Lauderdale, Fla. or the Remote Desktop Protocol (RDP) manufactured by the Microsoft Corporation of Redmond, Wash. The application can use any type of protocol and it can be, for example, an HTTP client, an FTP client, an Oscar client, or a Telnet client. In other embodiments, the application includes any type of software related to voice over internet protocol (VoIP) communications, such as a soft IP telephone. In further embodiments, the application includes any application related to real-time data communications, such as applications for streaming video and/or audio.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system, software, and a client agent 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In some embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output DRAM (EDO DRAM), Burst Extended Data Output DRAM (BEDO DRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with a display device 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc., of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments, the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 includes a combination of devices, such as a mobile phone combined with a digital audio player or portable media player. In one of these embodiments, the computing device 100 is a smartphone, for example, an iPhone manufactured by Apple Computer, or a Blackberry device, manufactured by Research In Motion Limited. In yet another embodiment, the computing device 100 is a laptop or desktop computer equipped with a web browser and a microphone and speaker system, such as a telephony headset. In these embodiments, the computing devices 100 are web-enabled and can receive and initiate phone calls. In other embodiments, the communications device 100 is a Motorola RAZR or Motorola ROKR line of combination digital audio players and mobile phones.

Network appliances are often used to provide access to one or more network services. A network appliance may comprise a number of virtual servers, each virtual server providing access to a number of services. The virtual servers may manage incoming connections from clients, and direct client requests to one or more services. In the course of managing incoming connection requests, network appliances may provide load balancing among the virtual servers. When a virtual server is down or unavailable to service a connection request, the appliance may use a backup virtual server to manage incoming connections.

A virtual server may be operational or available but not operating at a desired performance level. A network appliance may direct a client request or connection to a virtual server operating less than an optimal performance level. For example, a network appliance may direct a client request to a virtual server that is slow. In another example, the network appliance may direct a client request to a virtual server that is servicing a high amount of responses or network traffic. The virtual server may be using significant network capacity transferring requests and responses between clients and services. In some cases, the response time of the virtual server may increase if it handles additional client connections because of the limited availability of bandwidth. In other cases, the round trip times between the server and the virtual server or between the client and server may increase due to the limited availability of bandwidth.

Referring now to FIG. 1D, a network environment for delivering and/or operating a computing environment 15 on a client 102 is depicted. In some embodiments, a server 106 includes an application delivery system 190 for delivering a computing environment 15 or an application and/or data file to one or more clients 102. In brief overview, a client 102 is in communication with a server 106 via network 104, 104′ and appliance 200. For example, the client 102 may reside in a remote office of a company, e.g., a branch office, and the server 106 may reside at a corporate data center. The client 102 comprises a client agent 120, and a computing environment 15. The computing environment 15 may execute or operate an application that accesses, processes or uses a data file. The computing environment 15, application and/or data file may be delivered via the appliance 200 and/or the server 106.

In some embodiments, the appliance 200 accelerates delivery of a computing environment 15, or any portion thereof, to a client 102. In one embodiment, the appliance 200 accelerates the delivery of the computing environment 15 by the application delivery system 190. For example, the embodiments described herein may be used to accelerate delivery of a streaming application and data file processable by the application from a central corporate data center to a remote user location, such as a branch office of the company. In another embodiment, the appliance 200 accelerates transport layer traffic between a client 102 and a server 106. The appliance 200 may provide acceleration techniques for accelerating any transport layer payload from a server 106 to a client 102, such as: 1) transport layer connection pooling, 2) transport layer connection multiplexing, 3) transport control protocol buffering, 4) compression and 5) caching. In some embodiments, the appliance 200 provides load balancing of servers 106 in responding to requests from clients 102. In other embodiments, the appliance 200 acts as a proxy or access server to provide access to the one or more servers 106. In another embodiment, the appliance 200 provides a secure virtual private network connection from a first network 104 of the client 102 to a second network 104′ of the server 106, such as an SSL VPN connection. It yet other embodiments, the appliance 200 provides application firewall security, control and management of the connection and communications between a client 102 and a server 106.

In some embodiments, the application delivery management system 190 provides application delivery techniques to deliver a computing environment to a desktop of a user, remote or otherwise, based on a plurality of execution methods and based on any authentication and authorization policies applied via a policy engine 195. With these techniques, a remote user may obtain a computing environment and access to server-stored applications and data files from any network-connected device 100. In one embodiment, the application delivery system 190 may reside or execute on a server 106. In another embodiment, the application delivery system 190 may reside or execute on a plurality of servers 106a-106n. In some embodiments, the application delivery system 190 may execute in a server farm 38. In one embodiment, the server 106 executing the application delivery system 190 may also store or provide the application and data file. In another embodiment, a first set of one or more servers 106 may execute the application delivery system 190, and a different server 106n may store or provide the application and data file. In some embodiments, each of the application delivery system 190, the application, and data file may reside or be located on different servers. In yet another embodiment, any portion of the application delivery system 190 may reside, execute or be stored on or distributed to the appliance 200, or a plurality of appliances.

The client 102 may include a computing environment 15 for executing an application that uses or processes a data file. The client 102, via networks 104, 104′ and appliance 200, may request an application and data file from the server 106. In one embodiment, the appliance 200 may forward a request from the client 102 to the server 106. For example, the client 102 may not have the application and data file stored or accessible locally. In response to the request, the application delivery system 190 and/or server 106 may deliver the application and data file to the client 102. For example, in one embodiment, the server 106 may transmit the application as an application stream to operate in computing environment 15 on client 102.

In some embodiments, the application delivery system 190 comprises any portion of the CITRIX ACCESS SUITE by Citrix Systems, Inc., of Fort Lauderdale, Fla., such as the MetaFrame or CITRIX PRESENTATION SERVER, CITRIX XENAPP, CITRIX XEN DESKTOP and/or any of the MICROSOFT WINDOWS Terminal Services manufactured by the Microsoft Corporation of Redmond, Wash. In one embodiment, the application delivery system 190 may deliver one or more applications to clients 102 or users via a remote-display protocol or otherwise via remote-based or server-based computing. In another embodiment, the application delivery system 190 may deliver one or more applications to clients or users via steaming of the application.

In one embodiment, the application delivery system 190 includes a policy engine 195 for controlling and managing the access to, selection of application execution methods and the delivery of applications. In some embodiments, the policy engine 195 determines the one or more applications a user or client 102 may access. In another embodiment, the policy engine 195 determines how the application should be delivered to the user or client 102, e.g., the method of execution. In some embodiments, the application delivery system 190 provides a plurality of delivery techniques from which to select a method of application execution, such as a server-based computing method, streaming or delivering the application locally to the client 120 for local execution.

In one embodiment, a client 102 requests execution of an application program and the application delivery system 190 of a server 106 selects a method of executing the application program. In some embodiments, the server 106 receives credentials from the client 102. In another embodiment, the server 106 receives a request for an enumeration of available applications from the client 102. In one embodiment, in response to the request or receipt of credentials, the application delivery system 190 enumerates a plurality of application programs available to the client 102. The application delivery system 190 receives a request to execute an enumerated application. The application delivery system 190 selects one of a predetermined number of methods for executing the enumerated application, for example, responsive to a policy of a policy engine. The application delivery system 190 may select a method of execution of the application enabling the client 102 to receive application-output data generated by execution of the application program on a server 106. The application delivery system 190 may select a method of execution of the application enabling the client 102 to execute the application program locally after retrieving a plurality of application files comprising the application. In yet another embodiment, the application delivery system 190 may select a method of execution of the application to stream the application via the network 104 to the client 102.

Still referring to FIG. 1D, an embodiment of the network environment may include a monitoring server 106A. The monitoring server 106A may include any type and form performance monitoring service 198. The performance monitoring service 198 may include monitoring, measurement and/or management software and/or hardware, including data collection, aggregation, analysis, management and reporting. In one embodiment, the performance monitoring service 198 includes one or more monitoring agents 197. The monitoring agent 197 includes any software, hardware or combination thereof for performing monitoring, measurement and data collection activities on a device, such as a client 102, server 106 or an appliance 200. In some embodiments, the monitoring agent 197 includes any type and form of script, such as VISUAL BASIC script, or JAVASCRIPT. In one embodiment, the monitoring agent 197 executes transparently to any application and/or user of the device. In some embodiments, the monitoring agent 197 is installed and operated unobtrusively to the application or client. In yet another embodiment, the monitoring agent 197 is installed and operated without any instrumentation for the application or device.

In some embodiments, the monitoring agent 197 monitors, measures and collects data on a predetermined frequency. In other embodiments, the monitoring agent 197 monitors, measures and collects data based upon detection of any type and form of event. For example, the monitoring agent 197 may collect data upon detection of a request for a web page or receipt of an HTTP response. In another example, the monitoring agent 197 may collect data upon detection of any user input events, such as a mouse click. The monitoring agent 197 may report or provide any monitored, measured or collected data to the monitoring service 198. In one embodiment, the monitoring agent 197 transmits information to the monitoring service 198 according to a schedule or a predetermined frequency. In another embodiment, the monitoring agent 197 transmits information to the monitoring service 198 upon detection of an event.

In some embodiments, the monitoring service 198 and/or monitoring agent 197 performs monitoring and performance measurement of any network resource or network infrastructure element, such as a client 102, server 106, server farm 38, appliance 200, or network connection. In one embodiment, the monitoring service 198 and/or monitoring agent 197 performs monitoring and performance measurement of any transport layer connection, such as a TCP or UDP connection. In another embodiment, the monitoring service 198 and/or monitoring agent 197 monitors and measures network latency. In yet another embodiment, the monitoring service 198 and/or monitoring agent 197 monitors and measures bandwidth utilization.

In other embodiments, the monitoring service 198 and/or monitoring agent 197 monitors and measures end-user response times. In some embodiments, the monitoring service 198 performs monitoring and performance measurement of an application. In another embodiment, the monitoring service 198 and/or monitoring agent 197 performs monitoring and performance measurement of any session or connection to the application. In one embodiment, the monitoring service 198 and/or monitoring agent 197 monitors and measures performance of a browser. In another embodiment, the monitoring service 198 and/or monitoring agent 197 monitors and measures performance of HTTP based transactions. In some embodiments, the monitoring service 198 and/or monitoring agent 197 monitors and measures performance of a Voice over IP (VoIP) application or session. In other embodiments, the monitoring service 198 and/or monitoring agent 197 monitors and measures performance of a remote display protocol application, such as an ICA client or RDP client. In yet another embodiment, the monitoring service 198 and/or monitoring agent 197 monitors and measures performance of any type and form of streaming media. In still a further embodiment, the monitoring service 198 and/or monitoring agent 197 monitors and measures performance of a hosted application or a Software-As-A-Service (SaaS) delivery model.

In some embodiments, the monitoring service 198 and/or monitoring agent 197 performs monitoring and performance measurement of one or more transactions, requests or responses related to an application. In other embodiments, the monitoring service 198 and/or monitoring agent 197 monitors and measures any portion of an application layer stack, such as any .NET or J2EE calls. In one embodiment, the monitoring service 198 and/or monitoring agent 197 monitors and measures database or SQL transactions. In yet another embodiment, the monitoring service 198 and/or monitoring agent 197 monitors and measures any method, function or application programming interface (API) call.

In one embodiment, the monitoring service 198 and/or monitoring agent 197 performs monitoring and performance measurement of a delivery of application and/or data from a server 106 to a client 102 via one or more appliances, such as appliance 200. In some embodiments, the monitoring service 198 and/or monitoring agent 197 monitors and measures performance of delivery of a virtualized application. In other embodiments, the monitoring service 198 and/or monitoring agent 197 monitors and measures performance of delivery of a streaming application. In another embodiment, the monitoring service 198 and/or monitoring agent 197 monitors and measures performance of delivery of a desktop application to a client 102 and/or the execution of the desktop application on the client 102. In another embodiment, the monitoring service 198 and/or monitoring agent 197 monitors and measures performance of a client/server application.

In one embodiment, the monitoring service 198 and/or monitoring agent 197 is designed and constructed to provide application performance management for the application delivery system 190. For example, the monitoring service 198 and/or monitoring agent 197 may monitor, measure or manage the performance of the delivery of applications via the CITRIX PRESENTATION SERVER, CITRIX XENAPP, or CITRIX XEN DESKTOP solutions. In this example, the monitoring service 198 and/or monitoring agent 197 monitors individual presentation level protocol sessions, such as ICA sessions. The monitoring service 198 and/or monitoring agent 197 may measure the total and per session system resource usage, as well as application and networking performance. The monitoring service 198 and/or monitoring agent 197 may identify the active servers for a given user and/or user session. In some embodiments, the monitoring service 198 and/or monitoring agent 197 monitors back-end connections between the application delivery system 190 and an application and/or database server. The monitoring service 198 and/or monitoring agent 197 may measure network latency, delay and volume per user-session or ICA session.

In some embodiments, the monitoring service 198 and/or monitoring agent 197 measures and monitors memory usage for the application delivery system 190, such as total memory usage, per user session and/or per process. In other embodiments, the monitoring service 198 and/or monitoring agent 197 measures and monitors CPU usage of the application delivery system 190, such as total CPU usage, per user session and/or per process. In another embodiment, the monitoring service 198 and/or monitoring agent 197 measures and monitors the time required to log-in to an application, a server, or the application delivery system, such as a CITRIX PRESENTATION SERVER, CITRIX XENAPP, or CITRIX XEN DESKTOP system. In one embodiment, the monitoring service 198 and/or monitoring agent 197 measures and monitors the duration a user is logged into an application, a server, or the application delivery system 190. In some embodiments, the monitoring service 198 and/or monitoring agent 197 measures and monitors active and inactive session counts for an application, server 106 or application delivery system session. In yet another embodiment, the monitoring service 198 and/or monitoring agent 197 measures and monitors user session latency.

In yet further embodiments, the monitoring service 198 and/or monitoring agent 197 measures and monitors any type and form of server metrics. In one embodiment, the monitoring service 198 and/or monitoring agent 197 measures and monitors metrics related to system memory, CPU usage, and disk storage. In another embodiment, the monitoring service 198 and/or monitoring agent 197 measures and monitors metrics related to page faults, such as page faults per second. In other embodiments, the monitoring service 198 and/or monitoring agent 197 measures and monitors round-trip time metrics. In yet another embodiment, the monitoring service 198 and/or monitoring agent 197 measures and monitors metrics related to application crashes, errors and/or hangs.

In some embodiments, the monitoring service 198 and monitoring agent 197 includes a performance monitoring or end-user monitoring program, such as EDGESIGHT manufactured by Citrix Systems, Inc., of Ft. Lauderdale, Fla. In another embodiment, the performance monitoring service 198 and/or monitoring agent 197 includes any portion of the product embodiments referred to as the TRUEVIEW product suite manufactured by the Symphoniq Corporation of Palo Alto, Calif. In one embodiment, the performance monitoring service 198 and/or monitoring agent 197 includes any portion of the product embodiments referred to as the TEALEAF CX product suite manufactured by the TeaLeaf Technology Inc., of San Francisco, Calif. In other embodiments, the performance monitoring service 198 and/or monitoring agent 197 includes any portion of the business service management products, such as the BMC Performance Manager and PATROL products, manufactured by BMC Software, Inc., of Houston, Tex.

In some embodiments, a monitoring agent 197 may monitor and measure performance of any application of the client. In one embodiment, the monitoring agent 197 monitors and measures the performance of a browser on the client 102. In some embodiments, the monitoring agent 197 monitors and measures performance of any application delivered via the client agent 120. In other embodiments, the monitoring agent 197 measures and monitors end user response times for an application, such as web-based or HTTP response times. The monitoring agent 197 may monitor and measure performance of an ICA or RDP client. In another embodiment, the monitoring agent 197 measures and monitors metrics for a user session or application session. In some embodiments, monitoring agent 197 measures and monitors an ICA or RDP session. In one embodiment, the monitoring agent 197 measures and monitors the performance of the appliance 200 in accelerating delivery of an application and/or data to the client 102.

Referring now to FIG. 1E, an embodiment of a client agent 120 depicted. The client 102 includes a client agent 120 for establishing and exchanging communications with the appliance 200 and/or server 106 via a network 104. In brief overview, the client 102 operates on computing device 100 having an operating system with a kernel mode 302 and a user mode 303, and a network stack 267 with one or more layers 310a-310b. The client 102 may have installed and/or execute one or more applications. In some embodiments, one or more applications may communicate via the network stack 267 to a network 104. One of the applications, such as a web browser, may also include a first program 322. For example, the first program 322 may be used in some embodiments to install and/or execute the client agent 120, or any portion thereof. The client agent 120 includes an interception mechanism, or interceptor 350, for intercepting network communications from the network stack 267 from the one or more applications.

The client agent 120 includes an acceleration program 302, a streaming client 306, a collection agent 304, and/or monitoring agent 197. In one embodiment, the client agent 120 comprises an Independent Computing Architecture (ICA) client, or any portion thereof, developed by Citrix Systems, Inc., of Fort Lauderdale, Fla., and is also referred to as an ICA client. In some embodiments, the client 120 comprises an application streaming client 306 for streaming an application from a server 106 to a client 102. In some embodiments, the client agent 120 comprises an acceleration program 302 for accelerating communications between client 102 and server 106. In another embodiment, the client agent 120 includes a collection agent 304 for performing end-point detection/scanning and collecting end-point information for the appliance 200 and/or server 106.

In one embodiment, the collection agent 304 comprises an application, program, process, service, task or executable instructions for identifying, obtaining and/or collecting information about the client 102. In some embodiments, the appliance 200 transmits the collection agent 304 to the client 102 or client agent 120. The collection agent 304 may be configured according to one or more policies of the policy engine 236 of the appliance. In other embodiments, the collection agent 304 transmits collected information on the client 102 to the appliance 200. In one embodiment, the policy engine 236 of the appliance 200 uses the collected information to determine and provide access, authentication and authorization control of the client's connection to a network 104.

In one embodiment, the collection agent 304 comprises an end-point detection and scanning mechanism, which identifies and determines one or more attributes or characteristics of the client. For example, the collection agent 304 may identify and determine one or more of the following client-side attributes: 1) the operating system and/or a version of an operating system, 2) a service pack of the operating system, 3) a running service, 4) a running process, and 5) a file. The collection agent 304 may also identify and determine the presence or versions of any one or more of the following on the client: 1) antivirus software, 2) personal firewall software, 3) anti-spam software, and 4) internet security software. The policy engine 236 may have one or more policies based on any one or more of the attributes or characteristics of the client or client-side attributes.

FIG. 1F illustrates an example embodiment of the appliance 200. The architecture of the appliance 200 in FIG. 1F is provided by way of illustration only and is not intended to be limiting. As shown in FIG. 1F, in one embodiment, an appliance 200 comprises a hardware layer 206 and a software layer divided into a user space 202 and a kernel space 204.

Hardware layer 206 provides the hardware elements upon which programs and services within kernel space 204 and user space 202 are executed. Hardware layer 206 also provides the structures and elements which allow programs and services within kernel space 204 and user space 202 to communicate data both internally and externally with respect to appliance 200. As shown in FIG. 1F, the hardware layer 206 includes a processing unit 262 for executing software programs and services, a memory 264 for storing software and data, network ports 266 for transmitting and receiving data over a network, and an encryption processor 260 for performing functions related to Secure Sockets Layer processing of data transmitted and received over the network. In some embodiments, a central processing unit 262 may perform the functions of the encryption processor 260 in a single processor. Additionally, the hardware layer 206 may comprise multiple processors for each of the processor 262 and the encryption processor 260. The processor 262 may include any of the processors 121 described above in connection with FIGS. 1B and 1C. In some embodiments, a central processing unit 262 may perform the functions of the encryption processor 260 in a single processor. Additionally, the hardware layer 206 may comprise multiple processors for each of the processing unit 262 and the encryption processor 260. For example, in one embodiment, the appliance 200 comprises a first processor 262 and a second processor 262′. In other embodiments, the processor 262 or 262′ comprises a multi-core processor.

Although the hardware layer 206 of appliance 200 is generally illustrated with an encryption processor 260, the encryption processor 260 may be a processor for performing functions related to any encryption protocol, such as the Secure Socket Layer (SSL) or Transport Layer Security (TLS) protocol. In some embodiments, the encryption processor 260 may be a general purpose processor (GPP), and in further embodiments, may include executable instructions for performing processing of any security related protocol.

Although the hardware layer 206 of appliance 200 is illustrated with certain elements in FIG. 1F, the hardware portions or components of appliance 200 may comprise any type and form of elements, hardware or software, of a computing device, such as the computing device 100 illustrated and discussed herein in conjunction with FIGS. 1B and 1C. In some embodiments, the appliance 200 may comprise a server 106, gateway, router, switch, bridge or other type of computing or network device, and have any hardware and/or software elements associated therewith.

The operating system of appliance 200 allocates, manages, or otherwise segregates the available system memory into kernel space 204 and user space 202. In one example software architecture 200, the operating system may be any type and/or form of UNIX operating system. As such, the appliance 200 can be running any operating system such as any version of the MICROSOFT WINDOWS operating systems, Unix and Linux operating systems, MAC OS for Macintosh computers, any embedded operating system, any network operating system, any real-time operating system, any open source operating system, any proprietary operating system, any operating systems for mobile computing devices or network devices, or any other operating system capable of running on the appliance 200 and performing the operations described herein.

The kernel space 204 is reserved for running the kernel 230, including any device drivers, kernel extensions or other kernel related software. As known to those skilled in the art, the kernel 230 is the core of the operating system, and provides access, control, and management of resources and hardware-related elements of the appliance 200. In accordance with an embodiment of the appliance 200, the kernel space 204 also includes a number of network services or processes working in conjunction with a cache manager 232, sometimes referred to as the integrated cache, the benefits of which are described in detail further herein. Additionally, the embodiment of the kernel 230 will depend on the embodiment of the operating system installed, configured, or otherwise used by the device 200.

In one embodiment, the device 200 comprises one network stack 267, such as a TCP/IP based stack, for communicating with the client 102 and/or the server 106. In another embodiment, the network stack 267 is used to communicate with a first network, such as network 104, and a second network 104′. In some embodiments, the device 200 terminates a first transport layer connection, such as a TCP connection of a client 102, and establishes a second transport layer connection to a server 106 for use by the client 102, for example, the second transport layer connection is terminated at the appliance 200 and the server 106. The first and second transport layer connections may be established via a single network stack 267. In other embodiments, the device 200 may comprise multiple network stacks, for example 267 and 267′ (not shown), and the first transport layer connection may be established or terminated at one network stack 267, and the second transport layer connection on the second network stack 267′. For example, one network stack may be for receiving and transmitting network packet on a first network, and another network stack for receiving and transmitting network packets on a second network. In one embodiment, the network stack 267 comprises a buffer 243 for queuing one or more network packets for transmission by the appliance 200.

As shown in FIG. 1F, the kernel space 204 includes the cache manager 232, a high-speed layer 2-7 integrated packet engine 240, an encryption engine 234, a policy engine 236 and multi-protocol compression logic 238. Running these components or processes 232, 240, 234, 236 and 238 in kernel space 204 or kernel mode instead of the user space 202 improves the performance of each of these components, alone or in combination. Kernel operation means that these components or processes 232, 240, 234, 236 and 238 run in the core address space of the operating system of the device 200. For example, running the encryption engine 234 in kernel mode improves encryption performance by moving encryption and decryption operations to the kernel, thereby reducing the number of transitions between the memory space or a kernel thread in kernel mode and the memory space or a thread in user mode. For example, data obtained in kernel mode may not need to be passed or copied to a process or thread running in user mode, such as from a kernel level data structure to a user level data structure. In another aspect, the number of context switches between kernel mode and user mode are reduced. Additionally, synchronization of and communications between any of the components or processes 232, 240, 235, 236 and 238 can be performed more efficiently in the kernel space 204.

In some embodiments, any portion of the components 232, 240, 234, 236 and 238 may run or operate in the kernel space 204, while other portions of these components 232, 240, 234, 236 and 238 may run or operate in user space 202. In one embodiment, the appliance 200 uses a kernel-level data structure providing access to any portion of one or more network packets, for example, a network packet comprising a request from a client 102 or a response from a server 106. In some embodiments, the kernel-level data structure may be obtained by the packet engine 240 via a transport layer driver interface or filter to the network stack 267. The kernel-level data structure may comprise any interface and/or data accessible via the kernel space 204 related to the network stack 267, network traffic or packets received or transmitted by the network stack 267. In other embodiments, the kernel-level data structure may be used by any of the components or processes 232, 240, 234, 236 and 238 to perform the desired operation of the component or process. In one embodiment, a component 232, 240, 234, 236 and 238 is running in kernel mode 204 when using the kernel-level data structure, while in another embodiment, the component 232, 240, 234, 236 and 238 is running in user mode when using the kernel-level data structure. In some embodiments, the kernel-level data structure may be copied or passed to a second kernel-level data structure, or any desired user-level data structure.

The cache manager 232 may comprise software, hardware or any combination of software and hardware to provide cache access, control and management of any type and form of content, such as objects or dynamically generated objects served by the originating servers 106. The data, objects or content processed and stored by the cache manager 232 may comprise data in any format, such as a markup language, or communicated via any protocol. In some embodiments, the cache manager 232 duplicates original data stored elsewhere or data previously computed, generated or transmitted, in which the original data may require longer access time to fetch, compute or otherwise obtain relative to reading a cache memory element. Once the data is stored in the cache memory element, future use can be made by accessing the cached copy rather than refetching or recomputing the original data, thereby reducing the access time. In some embodiments, the cache memory element may comprise a data object in memory 264 of the appliance 200. In other embodiments, the cache memory element may comprise a memory having a faster access time than memory 264. In another embodiment, the cache memory element may comprise any type and form of storage element of the device 200, such as a portion of a hard disk. In some embodiments, the processing unit 262 may provide cache memory for use by the cache manager 232. In yet other embodiments, the cache manager 232 may use any portion and combination of memory 264, storage, or the processing unit 262 for caching data, objects, and other content.

Furthermore, the cache manager 232 includes any logic, functions, rules, or operations to perform any embodiments of the techniques of the appliance 200 described herein. For example, the cache manager 232 includes logic or functionality to invalidate objects based on the expiration of an invalidation time period or upon receipt of an invalidation command from a client 102 or server 106. In some embodiments, the cache manager 232 may operate as a program, service, process or task executing in the kernel space 204, and in other embodiments, in the user space 202. In one embodiment, a first portion of the cache manager 232 executes in the user space 202 while a second portion executes in the kernel space 204. In some embodiments, the cache manager 232 can comprise any type of general purpose processor (GPP), or any other type of integrated circuit, such as a Field Programmable Gate Array (FPGA), Programmable Logic Device (PLD), or Application Specific Integrated Circuit (ASIC).

The policy engine 236 may include, for example, an intelligent statistical engine or other programmable application(s). In one embodiment, the policy engine 236 provides a configuration mechanism to allow a user to identify, specify, define or configure a caching policy. Policy engine 236, in some embodiments, has access to memory to support data structures such as lookup tables or hash tables to enable user-selected caching policy decisions. In other embodiments, the policy engine 236 may comprise any logic, rules, functions or operations to determine and provide access, control and management of objects, data or content being cached by the appliance 200 in addition to access, control and management of security, network traffic, network access, compression or any other function or operation performed by the appliance 200. Further examples of specific caching policies are further described herein.

In some embodiments, the policy engine 236 may provide a configuration mechanism to allow a user to identify, specify, define or configure policies directing behavior of any other components or functionality of an appliance, including without limitation the components described in FIG. 1G such as vServers 275, VPN functions 280, Intranet IP functions 282, switching functions 284, DNS functions 286, acceleration functions 288, application firewall functions 290, and monitoring agents 197. In other embodiments, the policy engine 236 may check, evaluate, implement, or otherwise act in response to any configured policies, and may also direct the operation of one or more appliance functions in response to a policy.

The encryption engine 234 comprises any logic, business rules, functions or operations for handling the processing of any security related protocol, such as SSL or TLS, or any function related thereto. For example, the encryption engine 234 encrypts and decrypts network packets, or any portion thereof, communicated via the appliance 200. The encryption engine 234 may also setup or establish SSL or TLS connections on behalf of a client 102, a server 106, or an appliance 200. As such, the encryption engine 234 provides offloading and acceleration of SSL processing. In one embodiment, the encryption engine 234 uses a tunneling protocol to provide a virtual private network between a client 102 and a server 106. In some embodiments, the encryption engine 234 is in communication with the Encryption processor 260. In other embodiments, the encryption engine 234 comprises executable instructions running on the Encryption processor 260.

The multi-protocol compression engine 238 comprises any logic, business rules, function or operations for compressing one or more protocols of a network packet, such as any of the protocols used by the network stack 267 of the appliance 200. In one embodiment, a multi-protocol compression engine 238 compresses bi-directionally between a plurality of clients 102a-102n and a plurality of servers 106a-106n in any TCP/IP based protocol, including Messaging Application Programming Interface (MAPI) (email), File Transfer Protocol (FTP), HyperText Transfer Protocol (HTTP), Common Internet File System (CIFS) protocol (file transfer), Independent Computing Architecture (ICA) protocol, Remote Desktop Protocol (RDP), Wireless Application Protocol (WAP), Mobile IP protocol, and Voice Over IP (VoIP) protocol. In other embodiments, the multi-protocol compression engine 238 provides compression of Hypertext Markup Language (HTML) based protocols and in some embodiments, provides compression of any markup languages, such as the Extensible Markup Language (XML).

In one embodiment, the multi-protocol compression engine 238 provides compression of any high-performance protocol, such as any protocol designed for appliance to appliance communications. In another embodiment, the multi-protocol compression engine 238 compresses any payload or any communication using a modified transport control protocol, such as Transaction TCP (T/TCP), TCP with selection acknowledgements (TCP-SACK), TCP with large windows (TCP-LW), a congestion prediction protocol such as the TCP-Vegas protocol, and a TCP spoofing protocol. As such, the multi-protocol compression engine 238 accelerates performance for users accessing applications via desktop clients, e.g., Microsoft Outlook and non-Web thin clients, such as any client launched by popular enterprise applications like ORACLE, SAP and SIEBEL, and even mobile clients, such as the POCKET PC. In some embodiments, the multi-protocol compression engine 238, by executing in the kernel mode 204 and integrating with the packet engine 240 accessing the network stack 267, is able to compress any of the protocols carried by the TCP/IP protocol, such as any application layer protocol.

High speed layer 2-7 integrated packet engine 240, also generally referred to as a packet processing engine or packet engine, manages the kernel-level processing of packets received and transmitted by the appliance 200 via a plurality of network ports 266. The high speed layer 2-7 integrated packet engine 240 may comprise a buffer for queuing one or more network packets during processing, such as for receipt of a network packet or transmission of a network packer. Additionally, the high speed layer 2-7 integrated packet engine 240 is in communication with one or more network stacks 267 to send and receive network packets via the network ports 266. The high speed layer 2-7 integrated packet engine 240 works in conjunction with the encryption engine 234, cache manager 232, policy engine 236 and multi-protocol compression logic 238. In particular, the encryption engine 234 is configured to perform SSL processing of packets, the policy engine 236 is configured to perform functions related to traffic management such as request-level content switching and request-level cache redirection, and the multi-protocol compression logic 238 is configured to perform functions related to compression and decompression of data.

In some embodiments, the high speed layer 2-7 integrated packet engine 240 includes a packet processing timer 242. In one embodiment, the packet processing timer 242 provides one or more time intervals to trigger the processing of incoming, i.e., received, or outgoing, i.e., transmitted, network packets. In some embodiments, the high speed layer 2-7 integrated packet engine 240 processes network packets responsive to the timer 242. The packet processing timer 242 provides any type and form of signal to the packet engine 240 to notify, trigger, or communicate a time-related event, interval or occurrence. In many embodiments, the packet processing timer 242 operates in the order of milliseconds, such as for example 100 ms, 50 ms or 25 ms. For example, in some embodiments, the packet processing timer 242 provides time intervals or otherwise causes a network packet to be processed by the high speed layer 2-7 integrated packet engine 240 at a 10 ms time interval, while in other embodiments, at a five ms time interval, and still yet in further embodiments, as short as a 3, 2, or one ms time interval. The high speed layer 2-7 integrated packet engine 240 may be interfaced, integrated or in communication with the encryption engine 234, cache manager 232, policy engine 236 and multi-protocol compression engine 238 during operation. As such, any of the logic, functions, or operations of the encryption engine 234, cache manager 232, policy engine 236 and multi-protocol compression logic 238 may be performed responsive to the packet processing timer 242 and/or the packet engine 240. Therefore, any of the logic, functions, or operations of the encryption engine 234, cache manager 232, policy engine 236 and multi-protocol compression logic 238 may be performed at the granularity of time intervals provided via the packet processing timer 242, for example, at a time interval of less than or equal to 10 ms. For example, in one embodiment, the cache manager 232 may perform invalidation of any cached objects responsive to the high speed layer 2-7 integrated packet engine 240 and/or the packet processing timer 242. In another embodiment, the expiry or invalidation time of a cached object can be set to the same order of granularity as the time interval of the packet processing timer 242, such as at every 10 ms.

In contrast to kernel space 204, user space 202 is the memory area or portion of the operating system used by user mode applications or programs otherwise running in user mode. A user mode application may not access kernel space 204 directly and uses service calls in order to access kernel services. As shown in FIG. 1F, the user space 202 of an appliance 200 includes a graphical user interface (GUI) 210, a command line interface (CLI) 212, shell services 214, health monitoring programs 216, and daemon services 218. GUI 210 and CLI 212 provide means by which a system administrator or other user can interact with and control the operation of the appliance 200, such as via the operating system of the appliance 200, either in the user space 202 or kernel space 204. The GUI 210 may be any type and form of graphical user interface and may be presented via text, graphical or otherwise, by any type of program or application, such as a browser. The CLI 212 may be any type and form of command line or text-based interface, such as a command line provided by the operating system. For example, the CLI 212 may comprise a shell, which is a tool to enable users to interact with the operating system. In some embodiments, the CLI 212 may be provided via a bash, csh, tcsh, or ksh type shell. The shell services 214 comprises programs, services, tasks, processes or executable instructions to support interaction with the appliance 200 or operating system by a user via the GUI 210 and/or CLI 212.

In one embodiment, a health monitoring program 216 is used to monitor, check, report and ensure that network systems are functioning properly and that users are receiving requested content over a network. A health monitoring program 216 comprises one or more programs, services, tasks, processes or executable instructions to provide logic, rules, functions or operations for monitoring any activity of the appliance 200. In some embodiments, the health monitoring program 216 intercepts and inspects any network traffic passed via the appliance 200. In other embodiments, the health monitoring program 216 interfaces by any suitable means and/or mechanisms with one or more of the following: the encryption engine 234, cache manager 232, policy engine 236, multi-protocol compression logic 238, packet engine 240, daemon services 218, and shell services 214. As such, the health monitoring program 216 may call any application programming interface (API) to determine a state, status, or health of any portion of the appliance 200. For example, the health monitoring program 216 may ping or send a status inquiry on a periodic basis to check if a program, process, service or task is active and currently running. In another example, the health monitoring program 216 may check any status, error or history logs provided by any program, process, service or task to determine any condition, status or error with any portion of the appliance 200.

In one embodiment, daemon services 218 are programs that run continuously or in the background and handle periodic service requests received by appliance 200. In some embodiments, a daemon service 218 may forward the requests to other programs or processes, such as another daemon service 218′ as appropriate. As known to those skilled in the art, a daemon service 218 may run unattended to perform continuous or periodic system wide functions, such as network control, or to perform any desired task. In some embodiments, one or more daemon services 218 may run in the user space 202, while in other embodiments, one or more daemon services 218 may run in the kernel space.

Referring now to FIG. 1G, another embodiment of the appliance 200 is depicted. In brief overview, the appliance 200 provides one or more of the following services, functionality or operations: SSL VPN connectivity 280, switching/load balancing 284, Domain Name Service resolution 286, acceleration 288 and an application firewall 290 for communications between one or more clients 102 and one or more servers 106. Each of the servers 106 may provide one or more network-related services 270a-270n (referred to as services 270). For example, a server 106 may provide an http service 270. The appliance 200 comprises one or more virtual servers or virtual internet protocol servers, referred to as a vServer, VIP server, or just VIP 275a-275n (also referred herein as vServer 275). The vServer 275 receives, intercepts or otherwise processes communications between a client 102 and a server 106 in accordance with the configuration and operations of the appliance 200.

The vServer 275 may comprise software, hardware or any combination of software and hardware. The vServer 275 may comprise any type and form of program, service, task, process or executable instructions operating in user mode 202, kernel mode 204 or any combination thereof in the appliance 200. The vServer 275 includes any logic, functions, rules, or operations to perform any embodiments of the techniques described herein, such as SSL VPN 280, switching/load balancing 284, Domain Name Service resolution 286, acceleration 288 and an application firewall 290. In some embodiments, the vServer 275 establishes a connection to a service 270 of a server 106. The service 270 may comprise any program, application, process, task or set of executable instructions capable of connecting to and communicating to the appliance 200, client 102 or vServer 275. For example, the service 275 may comprise a web server, http server, ftp, email or database server. In some embodiments, the service 270 is a daemon process or network driver for listening, receiving and/or sending communications for an application, such as email, database or an enterprise application. In some embodiments, the service 270 may communicate on a specific IP address, or IP address and port.

In some embodiments, the vServer 275 applies one or more policies of the policy engine 236 to network communications between a client 102 and a server 106. In one embodiment, the policies are associated with a vServer 275. In another embodiment, the policies are based on a user, or a group of users. In yet another embodiment, a policy is global and applies to one or more vServers 275a-275n, and any user or group of users communicating via the appliance 200. In some embodiments, the policies of the policy engine have conditions upon which the policy is applied based on any content of the communication, such as internet protocol address, port, protocol type, header or fields in a packet, or the context of the communication, such as user, group of the user, vServer 275, transport layer connection, and/or identification or attributes of the client 102 or server 106.

In other embodiments, the appliance 200 communicates or interfaces with the policy engine 236 to determine authentication and/or authorization of a remote user or a remote client 102 to access the computing environment 15, application, and/or data file from a server 106. In another embodiment, the appliance 200 communicates or interfaces with the policy engine 236 to determine authentication and/or authorization of a remote user or a remote client 102 to have the application delivery system 190 deliver one or more of the computing environment 15, application, and/or data file. In yet another embodiment, the appliance 200 establishes a VPN or SSL VPN connection based on the policy engine's 236 authentication and/or authorization of a remote user or a remote client 102. In one embodiment, the appliance 200 controls the flow of network traffic and communication sessions based on policies of the policy engine 236. For example, the appliance 200 may control the access to a computing environment 15, application or data file based on the policy engine 236.

In some embodiments, the vServer 275 establishes a transport layer connection, such as a TCP or UDP connection with a client 102 via the client agent 120. In one embodiment, the vServer 275 listens for and receives communications from the client 102. In other embodiments, the vServer 275 establishes a transport layer connection, such as a TCP or UDP connection with a client server 106. In one embodiment, the vServer 275 establishes the transport layer connection to an internet protocol address and port of a server 270 running on the server 106. In another embodiment, the vServer 275 associates a first transport layer connection to a client 102 with a second transport layer connection to the server 106. In some embodiments, a vServer 275 establishes a pool of transport layer connections to a server 106 and multiplexes client requests via the pooled transport layer connections.

In some embodiments, the appliance 200 provides a SSL VPN connection 280 between a client 102 and a server 106. For example, a client 102 on a first network 104 requests to establish a connection to a server 106 on a second network 104′. In some embodiments, the second network 104′ is not routable from the first network 104. In other embodiments, the client 102 is on a public network 104 and the server 106 is on a private network 104′, such as a corporate network. In one embodiment, the client agent 120 intercepts communications of the client 102 on the first network 104, encrypts the communications, and transmits the communications via a first transport layer connection to the appliance 200. The appliance 200 associates the first transport layer connection on the first network 104 to a second transport layer connection to the server 106 on the second network 104′. The appliance 200 receives the intercepted communication from the client agent 120, decrypts the communications, and transmits the communication to the server 106 on the second network 104′ via the second transport layer connection. The second transport layer connection may be a pooled transport layer connection. As such, the appliance 200 provides an end-to-end secure transport layer connection for the client 102 between the two networks 104, 104′.

In one embodiment, the appliance 200 hosts an intranet internet protocol or IntranetIP 282 address of the client 102 on the virtual private network 104. In another embodiment, the appliance 200 hosts a local network identifier, such as an internet protocol (IP) address and/or host name of the client 102 on the network 104. When connected to the second network 104′ via the appliance 200, the appliance 200 establishes, assigns or otherwise provides the IntranetIP 282, or other network identifier, such as a IP address and/or host name, for the client 102 on the second network 104′. The appliance 200 listens for and receives on the second network 104′ for any communications directed towards the client 102 using the client's established IntranetIP 282. In one embodiment, the appliance 200 acts as, or on behalf of, the client 102 on the second network 104′. For example, in another embodiment, a vServer 275 listens for and responds to communications to the IntranetIP 282 of the client 102. In some embodiments, if a computing device 100 on the second network 104′ transmits a request, the appliance 200 processes the request as if it were the client 102. For example, the appliance 200 may respond to a ping to the client's IntranetIP 282. In another example, the appliance 200 may establish a connection, such as a TCP or UDP connection, with computing device 100 on the second network 104′ requesting a connection with the client's IntranetIP 282.

In some embodiments, the appliance 200 provides one or more of the following acceleration techniques 288 to communications between the client 102 and server 106: 1) compression; 2) decompression; 3) Transmission Control Protocol pooling; 4) Transmission Control Protocol multiplexing; 5) Transmission Control Protocol buffering; and 6) caching.

In one embodiment, the appliance 200 relieves the servers 106 of much of the processing load caused by repeatedly opening and closing transport layer connections to the clients 102 by opening one or more transport layer connections with each server 106 and maintaining these connections to allow repeated data accesses by the clients via the Internet. This technique is referred to herein as “connection pooling”.

In some embodiments, in order to seamlessly splice communications from a client 102 to a server 106 via a pooled transport layer connection, the appliance 200 translates or multiplexes communications by modifying sequence numbers and acknowledgment numbers at the transport layer protocol level. This is referred to as “connection multiplexing”. In some embodiments, no application layer protocol interaction is required. For example, in the case of an in-bound packet (that is, a packet received from a client 102), the source network address of the packet is changed to that of an output port of appliance 200, and the destination network address is changed to that of the intended server. In the case of an outbound packet (that is, one received from a server 106), the source network address is changed from that of the server 106 to that of an output port of appliance 200 and the destination address is changed from that of appliance 200 to that of the requesting client 102. The sequence numbers and acknowledgment numbers of the packet are also translated to sequence numbers and acknowledgement expected by the client 102 on the appliance's 200 transport layer connection to the client 102. In some embodiments, the packet checksum of the transport layer protocol is recalculated to account for these translations.

In another embodiment, the appliance 200 provides switching 284 or load-balancing functionality for communications between the client 102 and server 106. In some embodiments, the appliance 200 distributes traffic and directs client requests to a server 106 based on layer 4 or application-layer request data. In one embodiment, although the network layer or layer 2 of the network packet identifies a destination server 106, the appliance 200 determines the server 106 to distribute the network packet based on application information and data carried as payload of the transport layer packet. In one embodiment, the health monitoring programs 216 of the appliance 200 monitor the health of servers to determine the server 106 for which to distribute a client's request. In some embodiments, if the appliance 200 detects that a server 106 is not available or has a load over a predetermined threshold, the appliance 200 can direct or distribute client requests to another server 106.

In some embodiments, the appliance 200 acts as a Domain Name Service (DNS) resolver or otherwise provides resolution of a DNS request from a plurality of clients 102. In some embodiments, the appliance intercepts a DNS request transmitted by the client 102. In one embodiment, the appliance 200 responds to a client's DNS request with an IP address associated with the appliance 200. In this embodiment, the client 102 transmits network communication for a domain name to the appliance 200. In another embodiment, the appliance 200 responds to a client's DNS request with an IP address of or hosted by a second appliance 200′. In some embodiments, the appliance 200 responds to a client's DNS request with an IP address of a server 106 determined by the appliance 200.

In yet another embodiment, the appliance 200 provides application firewall functionality 290 for communications between the client 102 and server 106. In one embodiment, the policy engine 236 provides rules for detecting and blocking illegitimate requests. In some embodiments, the application firewall 290 protects against denial of service (DoS) attacks. In other embodiments, the appliance 200 inspects the content of intercepted requests to identify and block application-based attacks. In some embodiments, the rules/policy engine 236 comprises one or more application firewall or security control policies for providing protections against various classes and types of web or Internet based vulnerabilities, such as one or more of the following: 1) buffer overflow, 2) CGI-BIN parameter manipulation, 3) form/hidden field manipulation, 4) forceful browsing, 5) cookie or session poisoning, 6) broken access control list (ACLs) or weak passwords, 7) cross-site scripting (XSS), 8) command injection, 9) SQL injection, 10) error triggering sensitive information leak, 11) insecure use of cryptography, 12) server misconfiguration, 13) back doors and debug options, 14) website defacement, 15) platform or operating systems vulnerabilities, and 16) zero-day exploits. In one embodiment, the application firewall 290 provides HTML form field protection in the form of inspecting or analyzing the network communication for one or more of the following: 1) required fields are returned, 2) no added field allowed, 3) read-only and hidden field enforcement, 4) drop-down list and radio button field conformance, and 5) form-field max-length enforcement. In some embodiments, the application firewall 290 ensures cookies are not modified. In other embodiments, the application firewall 290 protects against forceful browsing by enforcing legal URLs.

In still yet other embodiments, the application firewall 290 protects any confidential information contained in the network communication. The application firewall 290 may inspect or analyze any network communication in accordance with the rules or polices of the engine 236 to identify any confidential information in any field of the network packet. In some embodiments, the application firewall 290 identifies in the network communication one or more occurrences of a credit card number, password, social security number, name, patient code, contact information, and age. The encoded portion of the network communication may comprise these occurrences or the confidential information. Based on these occurrences, in one embodiment, the application firewall 290 may take a policy action on the network communication, such as prevent transmission of the network communication. In another embodiment, the application firewall 290 may rewrite, remove or otherwise mask such identified occurrence or confidential information.

In some embodiments, the appliance 200 comprises any of the network devices manufactured by Citrix Systems, Inc. of Ft. Lauderdale Fla., referred to as CITRIX NETSCALER devices. In other embodiments, the appliance 200 includes any of the product embodiments referred to as WEBACCELERATOR and BIGIP manufactured by F5 Networks, Inc. of Seattle, Wash. In another embodiment, the appliance 200 includes any of the DX acceleration device platforms and/or the SSL VPN series of devices, such as SA 700, SA 2000, SA 4000, and SA 6000 devices manufactured by Juniper Networks, Inc. of Sunnyvale, Calif. In yet another embodiment, the appliance 200 includes any application acceleration and/or security related appliances and/or software manufactured by Cisco Systems, Inc. of San Jose, Calif., such as the CISCO APPLICATION CONTROL ENGINE MODULE service software and network modules, and CISCO AVS series APPLICATION VELOCITY SYSTEM.

Still referring to FIG. 1G, the appliance 200 may include a performance monitoring agent 197. In one embodiment, the appliance 200 receives the monitoring agent 197 from a monitoring service 198 or monitoring server 106A as described above in connection with FIG. 1D. In some embodiments, the appliance 200 stores the monitoring agent 197 in storage, such as a disk, for delivery to any client 102 or server 106 in communication with the appliance 200. For example, in one embodiment, the appliance 200 transmits the monitoring agent 197 to a client 102 upon receiving a request to establish a transport layer connection. In other embodiments, the appliance 200 transmits the monitoring agent 197 upon establishing the transport layer connection with the client 102. In another embodiment, the appliance 200 transmits the monitoring agent 197 to the client upon intercepting or detecting a request for a web page. In yet another embodiment, the appliance 200 transmits the monitoring agent 197 to a client 102 or a server 106 in response to a request from the monitoring server 198. In one embodiment, the appliance 200 transmits the monitoring agent 197 to a second appliance 200′ (not shown).

In other embodiments, the appliance 200 executes the monitoring agent 197. In one embodiment, the monitoring agent 197 measures and monitors the performance of any application, program, process, service, task or thread executing on the appliance 200. For example, the monitoring agent 197 may monitor and measure performance and operation of vServers 275A-275N. In another embodiment, the monitoring agent 197 measures and monitors the performance of any transport layer connections of the appliance 200. In some embodiments, the monitoring agent 197 measures and monitors the performance of any user sessions traversing the appliance 200. In one embodiment, the monitoring agent 197 measures and monitors the performance of any virtual private network connections and/or sessions traversing the appliance 200, such as an SSL VPN session. In still further embodiments, the monitoring agent 197 measures and monitors the memory, CPU and disk usage and performance of the appliance 200. In yet another embodiment, the monitoring agent 197 measures and monitors the performance of any acceleration technique 288 performed by the appliance 200, such as SSL offloading, connection pooling and multiplexing, caching, and compression.

In one embodiment, the monitoring agent 197 may include functionality provided by a power management agent 220, a monitoring agent 144, 604, a server agent 824, or a client agent 120. In some embodiments, the monitoring agent 197 measures and monitors the performance of any load balancing and/or content switching 284 performed by the appliance 200. In other embodiments, the monitoring agent 197 measures and monitors the performance of application firewall 290 protection and processing performed by the appliance 200

Referring now to FIG. 1H, a block diagram of an appliance using a plurality of monitoring agents 144 to monitor a network service 270 is shown. In brief overview, an appliance 200 comprises a plurality of monitoring agents 144. Each of the plurality of monitoring agents is assigned to a service 270. In one embodiment, each of the plurality of monitoring agents may be assigned a weight. The monitoring agents 144 may also be referred to as probes or load monitors. In some embodiments, a monitoring agent 144 may reside in a client 120, a server 106, or a machine. In one of these embodiments, a monitoring agent 144 may include functionality provided by a power management agent 220, a monitoring agent 197, 604, a server agent 824, or a client agent 120.

Still referring to FIG. 1H, an appliance 200 comprises a plurality of monitoring agents 144. A monitoring agent 144 may comprise any program, script, daemon, or other computing routine that reports a performance or operational characteristic of a network service 270 to the appliance 200. A monitoring agent 144 may communicate with a network service 270 once, or on a predetermined frequency, such as every millisecond or second. In some embodiments, a monitoring agent 144 may use a request/reply messaging mechanism or protocol with the server 106. In other embodiments, a monitoring agent 144 may have a custom or proprietary exchange protocol for communicating with the server 106. In some embodiments, a single monitoring agent 144 may monitor a plurality of servers 106. In other embodiments, a plurality of monitoring agents 144 may monitor a single server 106. In still other embodiments, a plurality of monitoring agents 144 may each monitor a plurality of servers 106, wherein each of the plurality of servers 106 is monitored by a plurality of monitoring agents 144.

In the embodiment shown, the one or more monitoring agents 144 are associated with one or more network services 270. In other embodiments, the one or more monitoring agents 144 may monitor an appliance 200, a vServer 275, a network service 270, a client 102, or any other network resource.

In one embodiment, a user specifies a type of network service 270 to associate with the one or more monitoring agents 144. In another embodiment, a user may customize a monitoring agent 144. In still another embodiment, a generic monitoring agent 144 is used. In yet another embodiment, the one or more monitoring agents 144 determine the response time of the one or more network services 270 for responding to a request of one of the following types: ping, transport control protocol (TCP), TCP extended content verification, hypertext transfer protocol (HTTP), http extended content verification, hypertext transfer protocol secure (HTTPS), HTTPS extended content verification, user datagram protocol, domain name service, and file transfer protocol.

In some embodiments, the one or more monitoring agents 144 are protocol-specific agents, each monitoring agent 144 determining the availability for a network service of a particular protocol-type. In some embodiments, a monitoring agent 144 determines a response time of a server 106 or network service 270 to a TCP request. In one of these embodiments, the monitoring agent 144 uses a “TCP/ICMP echo request” command to send a datagram to the network service 270, receive a datagram from the network service 270 in response, and determine a response time based on the roundtrip time of the datagram. In another of these embodiments, the monitoring agent 144 verifies that the response from the network service 270 included expected content and did not contain errors.

In other embodiments, a monitoring agent 144 determines availability of a network service 270 to a UDP request. In one of these embodiments, the monitoring agent 144 uses a “UDP echo” command to send a datagram to the network service 270, receive a datagram from the network service 270 in response, and determine a response time based on the roundtrip time of the datagram. In another of these embodiments, the monitoring agent 144 verifies that the response from the network service 270 included expected content and did not contain errors. In still other embodiments, the monitoring agent 144 determines an availability of a network service 270 to an FTP request. In one of these embodiments, the monitoring agent 144 sends an FTP command, such as a “get” command or a “put” command, to the network service 270 and determines a time needed by the network service 270 to respond to the command. In another of these embodiments, the monitoring agent 144 verifies that the response from the network service 270 includes expected content, such as contents of a file requested by a “get” command, and does not contain errors.

In yet other embodiments, the monitoring agent 144 determines availability of a network service 270 to an HTTP request. In one of these embodiments, the monitoring agent 144 sends an HTTP command, such as a “get” request for a uniform resource locator (URL) or a file, to the network service 270 and determines a time needed by the network service 270 to respond to the request. In another of these embodiments, the monitoring agent 144 verifies that the response from the network service 270 includes expected content, such as the contents of a web page identified by the URL, and does not contain errors.

In further embodiments, the monitoring agent 144 determines an availability of a network service 270 to a DNS request. In one of these embodiments, the monitoring agent 144 sends a DNS request, such as a dnsquery or nslookup for a known network address, to the server 106 or network service 270 and determines a time needed by the server 106 or network service 270 to respond to the request. In another of these embodiments, the monitoring agent 144 verifies that the response from the network service 270 includes expected content, such as the domain name of a computing device 100 associated with the known network address, and does not contain errors.

A monitoring agent 144 may be assigned a weight by a network appliance 200. A weight may comprise an integer, decimal, or any other numeric indicator. In some embodiments, a user may configure the weight corresponding to a given monitoring agent 144. In some embodiments, a plurality of monitoring agents 144 may be assigned equal weight. In other embodiments, a plurality of monitoring agents may each be assigned different weights. The weights may be assigned to the monitors based on any criteria indicating relative importance, including without limitation importance of the monitored service, reliability of the monitoring mechanism, and the frequency of monitoring.

In one embodiment, a monitoring agent 144 may be assigned a weight based on the relative importance of the service 270 the appliance 200 monitors. For example, if most user requests in a given environment were HTTP requests, a monitoring agent 144 monitoring HTTP availability of a server 106 might be assigned a weight of 10, while a monitoring agent 144 monitoring FTP availability of a server 106 might be assigned a weight of three. Or, for example, if an administrator places a high priority on UDP applications, a monitoring agent 144 monitoring UDP availability of a server 106 may be assigned a weight of 20, while a DNS monitoring agent 144 may be assigned a weight of 5.

In some embodiments, an appliance 200 may compute a sum of the weights of the monitoring agents 144 currently reporting a network service 270 as operational. For example, if five monitoring agents 144, each assigned a weight of 30, are monitoring a network service 270, and three of the five monitoring agents 144 report the network service 270 as available, the appliance 200 may determine the sum of the monitoring agents 144 currently reporting the network service 270 as operational to be 90. Or for example, if only two monitoring agents 144, one with a weight of 20 and the other with a weight of 40, are reporting a server 106 as available, the appliance 200 may compute the sum of the monitoring agents 144 currently reporting a server 106 as operational to be 60.

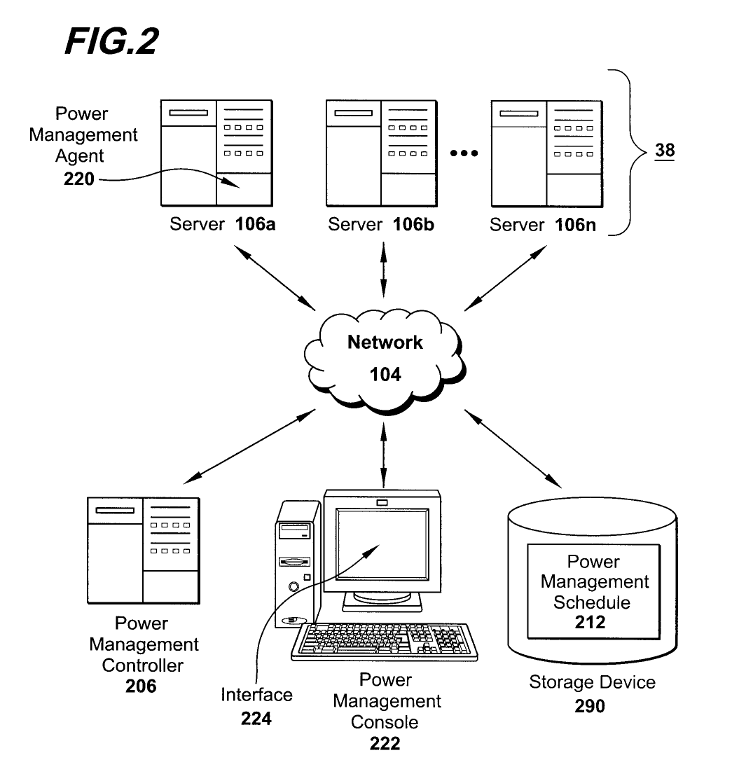

Referring now to FIG. 2, a block diagram depicts an embodiment of a system for adaptively load balancing user sessions and dynamically managing power modes for a plurality of servers 106 to reduce energy consumption. In brief overview, the system includes a power management controller 206, a power management console 222, a storage device 290 storing a power management schedule 212, and a plurality of servers 106 monitored by at least one power management agent 220. The power management console 222 identifies a session type for each of a plurality of user sessions, defines a server group providing access to a subset of the plurality of user sessions having a common session type, and defines a power management schedule 212 for the server group. The power management controller 206 consolidates, onto at least one server 106 in the server group, the subset of the plurality of user sessions. The power management agent 220 monitors a level of load on one of the plurality of servers 106. The power management console 222, in communication with the power management agent 220, defines a power management schedule 212 for the one of the plurality of servers 106, the power management schedule 212 generated responsive to the monitored level of load. The power management controller 206, in communication with the power management console 222 and the power management agent 220, dynamically controls a level of power to the one of the plurality of servers 106, responsive to the power management schedule 212.

In one embodiment, the at least one power management agent 220 transmits information associated with user sessions provided by the plurality of servers 106, to at least one of the power management console 222 and the power management controller 206. In another embodiment, the power management console 222 identifies a subset of the user sessions of a common session type and defines a server group to provide the subset of user sessions, responsive to the provided information. In still another embodiment, the power management console 222 defines a power management schedule 212 for the server group based on loading characteristics of the session type, to manage energy consumption. In yet another embodiment, the power management controller 206, based on loading information received from the at least one power management agent 220, and the power management schedule, controls the power level of a server 106 to reduce overall energy consumption.

Referring now to FIG. 2, and in greater detail, the system includes a server farm 38, the server farm 38 including a plurality of servers 106a-n (hereafter referred to generally as “a plurality of servers 106”). In one embodiment, the storage device 290 resides in a machine 106′ (not shown). In another embodiment, the plurality of servers 106, the power management controller 206, the power management console 222 and the machine 106′ may be any type of computing device 100 described above in connection with FIGS. 1A-1C.

In one embodiment, a plurality of servers 106 provides users of client machines 102 with access to networked resources. In another embodiment, each of the plurality of servers 106 may provide at least one user session to at least one client 102. In still another embodiment, one of the plurality of servers 106 providing access to a user session may execute one or more applications or process one or more files. In still even another embodiment, providing access to a network resource such as a resource accessed within a user session or the user session itself, places a computational burden on the server 106—a level of load. In yet another embodiment, the level of load associated with a user session represents, for example, processing resources used in executing one or more resources or processing one or more data files to the user.

In one embodiment, the level of load associated with a user session represents the total amount of processing resources associated with the user session, such as the accumulated processing resources utilized over a predetermined period of time. In another embodiment, the level of load associated with a user session represents the average amount of processing resources associated with the user session, derived from any type of statistical averaging such as arithmetic mean, geometric mean, harmonic mean, median and mode. In still another embodiment, the statistical averaging may be an instantaneous average, or an averaging performed over any duration of time. In yet another embodiment, the average amount of processing resources associated with the user session is a predicted value determined from a history of the processing resources utilized over a predetermined period of time.

In some embodiments, a level of load represents how many processes are in a queue for access to a processor in a server 106. In other embodiments, a level of load is a measure of work a system is doing. In further embodiments, a level of load is determined using techniques known to one ordinarily skilled in the art.

In one embodiment, the level of load associated with a user session may be determined from performance metrics associated with the server 106 providing the user session. In another embodiment, the performance metrics may include central processing unit (CPU) load, memory usage, paging activity, network activity, disk activity, and end-user performance metrics such as response latency. In still another embodiment, a power management agent 220 monitors the performance metrics on the server 106.

In one embodiment, the power management agent 220 may include functionality provided by a monitoring agent 144, 197, 604, a server agent 824, or a client agent 120, residing in a server 106, a client 102, or a machine. In another embodiment, each of the plurality of servers 106 includes a power management agent 220. In still another embodiment, the plurality of servers 106 includes at least one power management agent 220. In yet another embodiment, a power management agent 220 monitors the performance metrics associated with a subset of the plurality of servers 106.

In one embodiment, the power management agent 220 monitors a level of load associated with providing at least one user session, based on the monitored performance metrics, and communicates the level of load to a power management console 222. In another embodiment, the power management agent 220 transmits the performance metrics to a power management console 222. In still another embodiment, the power management console 222 determines a level of load associated with a user session, based on the received performance metrics.

In one embodiment, the power management agent 220 may associate a value from each monitored performance metric with each of a plurality of user sessions. In another embodiment, the power management agent 220 determines the level of load associated with one of the plurality of user sessions based on the associated values. In still another embodiment, the power management agent 220 communicates the determined level of load to a power management console 222. In still even another embodiment, the power management agent 220 transmits the performance metrics and values associated with a server 106 to a power management console 222. In yet another of these embodiments, the power management console 222 determines a level of load associated with a user session, based on the received performance metrics and values. In some embodiments, information associated with a level of load, and performance metrics and values associated with a user session is hereinafter referred to generally as “load information”.

In one embodiment, the power management agent 220 transmits load information to at least one of the power management console 222 and the power management controller 206. In another embodiment, the load information is transmitted on a regular basis, such as at a fixed time interval or according to a schedule. In another embodiment, the power management agent 220 transmits the load information in response to a request from the power management console 222 or the power management controller 206. For example, a user may initiate a request from a user interface 224 provided by the power management console 222. In still another embodiment, a plurality of power management agents 220 may work in concert or individually. For example, each of the plurality of power management agent 220 may monitor a subset of the plurality of servers 106 or the server farm 38, and a central power management agent 220 may collect the load information monitored by the plurality of power management agent 220 before transmitting to at least one of the power management console 222 and the power management controller 206.

In one embodiment, the power management agent 220 provides, to at least one of the power management console 222 and the power management controller 206, information for identifying a session type for at least one of the plurality of user sessions. In another embodiment, the information for identifying a session type for at least one of the plurality of user sessions includes load information. In still another embodiment, the information for identifying a session type for at least one of the plurality of user sessions includes information related to any application or data file included in the user session.

In one embodiment, an agent provided by a monitoring system transmits the performance metrics and values associated with a server 106 to at least one of the power management console 222 and the power management controller 206. In another embodiment, an agent provided by a monitoring system transmits load information to at least one of the power management console 222 and the power management controller 206. In still another embodiment, an agent provided by a monitoring system provides, to at least one of the power management console 222 and the power management controller 206, information for identifying a session type for at least one of the plurality of user sessions. In yet another embodiment, the monitoring system is a CITRIX EDGESIGHT system. In some embodiments, the agent includes functionality provided by a monitoring agent 144,197, 604, a server agent 824, or a client agent 120.

In one embodiment, a workflow system provides performance metrics and values associated with a server 106 to at least one of the power management console 222 and the power management controller 206. In another embodiment, a workflow system provides load information to at least one of the power management console 222 and the power management controller 206. In still another embodiment, a workflow system provides, to at least one of the power management console 222 and the power management controller 206, information for identifying a session type for at least one of the plurality of user sessions. In yet another embodiment, the workflow system is a CITRIX WORKFLOW STUDIO system.

In one embodiment, the information for identifying a session type includes information related to the usage profile or temporal nature of the user session, or the application or data file in the user session. For example, a user session or an application in the user session may be characterized as persistent or long-lived (such as a desktop session or an email client). In another embodiment, a user session or an application in the user session may be characterized as temporary, transient or short-lived (such as a telnet session or a web browser). In still another embodiment, a user session or an application in the user session may be characterized as ad-hoc (such as a file transfer protocol session or a fax software). In yet another embodiment, a user session or an application in the user session may be characterized as having a cyclic load pattern (such as a point-of-sale software application that is typically used heavily typically during the business hours of a day).

The power management console 222 provides an interface for identifying a session type for each of a plurality of user sessions, defining a server group providing access to a subset of the plurality of user sessions having a common session type, and defining a power management schedule 212 for the server group. The power management console 222, in communication with the power management agent 220, defines a power management schedule 212 for one of the plurality of servers 106, the power management schedule 212 generated responsive to the monitored level of load. In one embodiment, the power management console 222 receives, from the power management agent 220, the information for identifying a session type for each of the plurality of user sessions. In another embodiment, the power management console 222 provides an interface for identifying a session type for each of the plurality of user sessions. In still another embodiment, the power management console 222 automatically identifies a session type for each of the plurality of user sessions, responsive to the information received from the power management agent 220. In yet another embodiment, a user identifies, via the provided interface, a session type for each of the plurality of user sessions.

In one embodiment, the session type for a user session is identified as an application session. For example, server 206 may provide at least one application within an application session—such as a word processing or presentation program, (e.g., MICROSOFT POWERPOINT). In another embodiment, the session type for a user session is identified as a desktop session. For example, a server can provide a desktop session to a user at a client 102 from which the user may access a desktop environment that includes one or more applications and/or one or more data files. In still another embodiment, the session type for a user session is identified as a connection to a virtual machine. For example, the server 106 executes a hypervisor that provides a plurality of virtual machines on the server 106, and each of the plurality of virtual machines may be accessed via a connection to a client 102.

In one embodiment, a session type may be identified as a broad session type. In another embodiment, a broad session type may be further classified into a plurality of session types. For example, an application session, identified as a broad session type, may be further specified as one of a plurality of session types based on the usage profile or temporal nature of the application session. For example, an application or desktop session may be specified as one of the following session types: persistent, temporary, ad hoc and cyclic.

In one embodiment, the power management console 222 receives, from a power management agent 220, load information associated with a user session. In another embodiment, the power management console 222 provides an interface for identifying a level of load, responsive to the received load information associated with a user session. In still another embodiment, the identified level of load is associated with the session type of the user session.

The power management console 222 provides an interface 224 for defining a server group providing access to a subset of the plurality of user sessions having a common session type. In one embodiment, the power management console 222 provides a user an interface 224 for defining a server group. In another embodiment, a subset of the plurality of user sessions is identified as having a common session type. In still another embodiment, a server group provides access to a subset of the plurality of user sessions having a common session type. In yet another embodiment, a server group includes at least one server 106 substantially optimized to provide user sessions of a common session type. For example, servers including an AMD OPTERON processor are substantially optimized to execute 64-bit applications processing large data files. In still even another embodiment, a server group may include at least one server 106 substantially optimized to consume less power when providing a user session of a certain session type. For example, blade servers may be less power intensive than standalone desktop computers for executing a plurality of point-of-sale software programs.

In one embodiment, the power management console 222 provides an interface 224 for defining a power management schedule 212 for a server 106 in a plurality of servers 106. In another embodiment, the power management console 222 provides an interface for defining a power management schedule 212 for a server group. In still another embodiment, the power management console 222 automatically defines the power management schedule 212 responsive to identifying a session type for each of the plurality of user sessions. In yet another embodiment, the power management console 222 automatically defines the power management schedule 212 for a server group, responsive to defining the server group providing access to the subset of the plurality of user sessions having a common session type.

In one embodiment, a power management schedule 212 indicates the peak and off-peak periods for at least one of the plurality of servers 106. In another embodiment, a peak period identifies a time period during which the at least one of the plurality of servers 106 should be kept powered up for providing at least one user sessions. In still another embodiment, an off peak period identifies a time period during which the at least one of the plurality of servers 106 can be shutdown or placed in a low-power mode. In yet another embodiment, a power management schedule 212 may indicate time periods during which the at least one of the plurality of servers 106 is kept at a certain level of power, which may include a powered-down, a low power, an intermediate-power, and a high-power level. For example, a low power level may be represented by any of a sleep, dormant, standby, hibernation, power-saving, or low-power wait mode; an intermediate-power level may be represented by powering-down a subset of processors in a multi-core system.

In one embodiment, a power management schedule 212 can be applied to a single server 106, a subset of the plurality of servers 106, a server group, or a server farm 38. In another embodiment, the power management schedule 212 includes recommended directives for placing a server 106 in a certain level of power. In still another embodiment, the power management schedule 212 includes compulsory directives for placing a server 106 in a certain level of power. In yet another embodiment, the power management schedule 212 is stored in a storage device 290.

In one embodiment, the storage device 290 may be any type of memory 122 described above in connection with FIGS. 1B-1C. In another embodiment, the storage device 290 may include a plurality of distributed storage devices residing in one or more of the plurality of servers 106, the power management console 222, the power management controller 206, and any other machine connected to the network 104. In still another embodiment, the storage device 290 may be a persistent storage or a dynamic storage. In yet another embodiment, the storage device 290 is a virtual disk provided in a virtual machine environment.

In one embodiment, the storage device 290 may store at least one power management schedule 212. In another embodiment, the storage device 290 may store any form or type of information such as a level of load or power associated with a server 106 in the server farm 38, and lists of servers 106, user sessions, session types and server groups. In still another embodiment, the storage device 290 provides information for display, via an interface 224 provided by the power management console 222, to a user.

In one embodiment, a user provides a power management schedule 212 to the storage device 290 via the interface 224 provided by the power management console 222. In another embodiment, the interface 224 may receive a power management schedule 212 from a user via a file. In still another embodiment, the interface 224 is a command prompt interface. In yet another embodiment, the interface 224 is a graphical user interface (GUI). In still even another embodiment, a user may generate a power management schedule 212, via the provided interface.

In one embodiment, the interface 224 may provide any form or type of information to help a user generate a power management schedule 212. In another embodiment, the provided interface 224 may provide a representation of the plurality of servers 106 in the server farm 38, the server groups, the plurality of user sessions and their associated session types, and the monitored level of load and power of a server 106 or the server farm 38. In still another embodiment, the provided interface 224 may provide color coding and other visual aids to the representation, for example, to highlight an instance of server 106 loaded above a predetermined level of load or service level. In yet another embodiment, a hierarchical or structured representation of the server farm 38, server groups, and individual servers 106 may be provided as nodes in a GUI that can be collapsed or expanded via mouse or keyboard operations, for example. In still even another embodiment, the nodes may be expanded to reveal additional hierarchy and/or information, or collapsed to hide some hierarchy and/or information.

In one embodiment, the power management console 222 dynamically changes the power management schedule 212 for the server group, responsive to a change in a level of load on at least one server 106 in the server group. In another embodiment, the power management controller 206 dynamically changes the power management schedule 212 for the server group, responsive to a change in a level of load on at least one server 106 in the server group. In still another embodiment, the change in the level of load on the at least one server 106a in the server group may include exceeding a predetermined service level threshold such that another server 106b should be powered-up or revived from low-power mode, for example, to respond to a request for a new user session. In yet another embodiment, the change in the level of load may include falling below a predetermined service level threshold such that the server 106a can be powered-down or placed in low-power mode, for example, by migrating, in real-time, a virtual machine from the server 106a to another server 106b. In still even another embodiment, a server 106 may be powered-up or power-down for example, in anticipation for further changes in the level of load that may require higher or lower server capacity from the server group.

The power management controller 206 consolidates, onto at least one server 106 in the server group, the subset of the plurality of user sessions. In one embodiment, a power management controller 206 consolidates a subset of a plurality of user sessions having a common session type onto at least one server 106 in a server group. In another embodiment, the power management controller 206 consolidates, onto at least one server 106 substantially optimized for a session type, the subset of the plurality of user sessions of the session type. In still another embodiment, a power management controller 206 consolidates a subset of a plurality of user sessions having one or more session types onto at least one server 106 in a server group.

In one embodiment, a power management controller 206 evaluates a power management schedule 212 to determine whether to change a level of power on a server 106. In another embodiment, a power management controller 206, in communication with the power management console and the power management agent 220, dynamically controls a level of power to the server 106, responsive to the power management schedule. In still another embodiment, the power management controller 206 includes an agent (not shown) to generate a command to the power management agent 220 on the first server 106a to power down or enter into a low-power mode. For example, in one embodiment, a power management controller 206 may duplicate session state associated with a desktop session provided by a first server 106a to a client 102, on a second server 106b, and replace the user's access to the desktop session provided by the first server 106a with access to the duplicated desktop session provided by the second server 106b; the power management controller 206 may then power down the first server 106a. In yet another embodiment, the power management controller 206 may migrate, in real-time, a virtual machine executing on a first server 106a to a second server 106b. In still another embodiment, the power management controller 206 may consolidate all new user sessions having the common session type onto at least one server 106 in a server group.

In some embodiments, the power management controller 206 includes an agent (not shown) to dynamically allocate an available resource within the server group. In other embodiments, the power management controller 206 may provide a control system that evaluates the monitored level of load. In one of these embodiments, the control system includes a feedback mechanism to predict the level of load. In another of these embodiments, the control system may be able to react to moderately changing levels of load but not fast-changing levels of load. In still other embodiments, the power management controller 206 may provide a dynamic response system to respond to fast-changing levels of load. In one of these embodiments, the dynamic response system may override a control system. In another of these embodiments, the dynamic response system may operate only when fast-changing levels of load are detected by the agent.

In one embodiment, a resource within the server group may be a processor in a multi-processor system, memory, a communication port, a bus, a virtual server 275, or a server 106. In another embodiment, the power management controller 206 may allocate or re-allocate a resource to provide user sessions within a server group. In still another embodiment, when a server group is overloaded with user sessions, the power management controller 206 may allocate or re-allocate a resource across server groups. In still another embodiment, the power management controller 206 may relocate at least one of the subset of the plurality of user sessions from a first server 106a in the server group to a second server 106b in the server group. In still even another embodiment, the power management controller 206 may relocate at least one of the subset of the plurality of user sessions from a first server 106a in a first server group to a second server 106b in a second server group. In still another embodiment, the second server 106b may be powered up or revived from a power-saving mode to provide to relocated user sessions. In yet another embodiment, the power management controller 206 generates a command to at least one power management agent 220 to relocate a user session, power up a server 106, or revive a server 106.

In one embodiment, the power management controller 206 dynamically changes the power management schedule 212 for a server group, responsive to a change in a level of load on at least one server 106 in the server group. In another embodiment, the power management controller 206 updates the power management schedule 212 in response to at least one of the control system and the dynamic response system. In still another embodiment, the power management controller 206 dynamically allocates or re-allocates a resource, or dynamically relocates a user session between two servers 106, without changing the power management schedule 212. In yet another embodiment, the power management controller 206 selects a power management schedule 212, responsive to a change in a level of load on at least one server 106 in the server group, the power management schedule 212 selected from at least one power management schedule 212 stored in the storage device 290.

The power management controller 206, in communication with the power management console 222 and the power management agent 212, dynamically controls a level of power to the one of the plurality of servers 106, responsive to the power management schedule 212. In one embodiment, an agent in the power management controller 206 generates a command to direct a power management agent 220 to change the level of power on a server 106. In another embodiment, the agent generates a command to direct a power management agent 220 to place a server 106 in a power-down, low-power, intermediate-power, or high power state. In still another embodiment, the power management controller 206 includes a transmitter (not shown) for sending a command to the power management agent 220 to place the server 106 in a power-down, low-power, intermediate-power, or high power state. In yet another embodiment, the command may be transmitted to at least one power management agent 220 to relocate one or more user sessions between servers 106, for example in conjunction with changing the level of power on a server 106.

In one embodiment, the power management controller 206 receives status information associated with a server 106 from a power management agent 220 in addition to load information. In another embodiment, the power management controller 206 uses the status information to determine service limits on the server 106. For example, a service limit may include a predetermined level of memory swapping on a server 106 above which will result in reduced performance in an executing an application even though the CPU load is low. In still another embodiment, the power management console 222 uses service limits in response to a power management schedule 212 and/or a monitored level of load to determine whether to modify the power management schedule 212, allocate or re-allocate a resource, or relocate a user session. In yet another embodiment, the absence of status information associated with a server 106 from a power management agent 220 indicates that the server 106 is in a powered-down mode. In yet another embodiment, a transmission from a power management agent 220 acts as a “heart beat” signal indicating that a server 106 is responsive and functional.

In one embodiment, the power management controller 206 directs the power management agent 220, in conjunction with a plurality of external power control means, to control a level of power of a server 106. For example, in the case of blade servers in an intelligent chassis, the power management agent 220 can transmit a command to the intelligent chassis to power up or power down individual blade servers in the chassis. In another embodiment, the agent can transmit a command to control the power to a server 106 through network accessible power distribution controllers and/or uninterruptible power systems. In still another embodiment, the power management controller 206 can instruct the operating system of a server 106, via a power management agent 220, to direct the server 106 go into any power mode, and may make use of facilities such as Wake On LAN (WOL) to direct the server 106 to come out of a low power state. In yet another embodiment, WOL is a networking standard that allows a machine to be powered on or woken up remotely by a network message to the machine's network card or motherboard.

In one embodiment, the power management controller 206 can send a command to a server's baseboard management controller, via a power management agent 220, to control a level of power of the server 106, such as directing the server 106 to come out of a low power state. In another embodiment, the baseboard management controller is independent of the server's main processor and remains powered up when the server 106 is powered down. In still another embodiment, the power management agent 220, may or may not reside on the server 106, and remains operational or powered up when the server 106 is powered down.

In one embodiment, by dynamically altering the number of active servers 106 available, the power management controller 206 may trigger service limits such that other load evaluators (such as a load balancing controller) may attempt to spread the user session load across the server farm 38. In another embodiment, the consolidation process for reducing energy consumption can adapt to operate with a substantially optimal level of load on each server 106 using a minimal number of servers 106 while meeting minimum service levels.

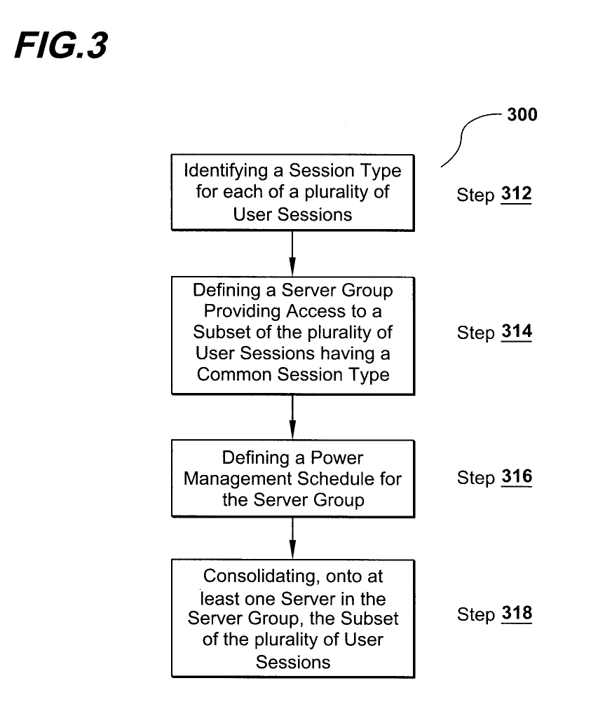

Referring now to FIG. 3, a flow diagram depicts one embodiment of the steps taken in a method 300 for adaptively load balancing user sessions to reduce energy consumption. In brief overview, the method includes identifying a session type for each of a plurality of user sessions (312). The method includes defining a server group providing access to a subset of the plurality of user sessions having a common session type (314). The method includes defining a power management schedule 212 for the server group (316). The method includes consolidating, onto at least one server 106 in the server group, the subset of the plurality of user sessions (318).

Referring now to FIG. 3, and in greater detail, a power management console 222 provides an interface 224 for identifying a session type for each of a plurality of user sessions (312). In one embodiment, a session type for each of a plurality of user sessions is identified based on information provided by a power management agent 220, the information related to each of the plurality of user sessions. In another embodiment, the power management console 222 receives, from the power management agent 220, information for identifying a session type for each of the plurality of user sessions. In still another embodiment, the power management agent 220 monitors a change in a level of load in each of the plurality of user sessions. In yet another embodiment, the power management agent 220 provides load information to the power management console 222, to identify the session type for each of the plurality of user sessions, wherein the load information includes a monitored change in a level of load in each of the plurality of user sessions. In still even another embodiment, the power management agent 220 provides information related to any application or data file included in each of the plurality of user sessions, to identify the session type for each of the plurality of user sessions.

In one embodiment, the power management console 222 automatically identifies the session type for each of the plurality of user sessions, based on the received information. In another embodiment, the power management console 222 displays the received information, via the interface 224, to a user. In still another embodiment, a user defines the session type for each of the plurality of user sessions, via the interface 224 provided by the power management console 222 based on the displayed information. In yet another embodiment, the power management console 222 displays the session type for each of the plurality of user sessions to a user, via the interface 224.

The power management console 222 provides an interface 224 for defining a server group providing access to a subset of the plurality of user sessions having a common session type (314). In one embodiment, the power management console 222 automatically defines a server group providing access to a subset of the plurality of user sessions having a common session type, responsive to identifying a session type for each of the plurality of user sessions. In another embodiment, the power management console 222 automatically defines a server group providing access to a subset of the plurality of user sessions having a common session type, responsive to the information received from at least one power management agent 220. In still another embodiment, a user defines, via an interface 224 provided by the power management console 222, a server group providing access to a subset of the plurality of user sessions having a common session type.

In one embodiment, the power management console 222 defines a server group including at least one server 106 substantially optimized to provide user sessions of a common session type. In another embodiment, a user defines, via an interface provided by the power management console 222, a server group including at least one server 106 substantially optimized to provide user sessions of a common session type. In still another embodiment, the user or the power management console 222 selects the server 106 substantially optimized to provide user sessions of a common session type from the plurality of servers 106 in the server farm 38. In yet another embodiment, the user or the power management console 222 defines the size of the server group, for example, based on the size of the plurality of user sessions and the monitored level of load on each of the plurality of user sessions.

The power management console 222 provides an interface 224 for defining a power management schedule for the server group (316). In one embodiment, a user defines, via an interface 224 provided by the power management console 222, a power management schedule 212 for the server group. In another embodiment, the power management console 222 automatically defines a power management schedule 212 for the server group, based on the received information from at least one power management agent 220. In still another embodiment, the power management console 222 or user selects a power management schedule 212 for the server group, the power management schedule 212 selected from at least one power management schedule 212 stored in the storage device 290. In yet another embodiment, the power management schedule 212 is defined responsive to the definition of a server group. In still even another embodiment, a power management schedule 212 is defined for at least one server 106 in a server group.

In one embodiment, the power management console 222 dynamically modifies a power management schedule 212 for the server group, responsive to a change in a level of load associated with a server 106. In another embodiment, the power management controller 206 dynamically modifies the power management schedule for the server group, responsive to a change in a level of load associated with a server 106. In still another embodiment, an agent in the power management controller 206 dynamically allocates or re-allocates an available resource within the server group, for example power up a server 106, responsive to a change in a level of load associated with a server 106. In yet another embodiment, an agent in the power management controller 206 generates a command to at least one power management agent 220 to allocate or re-allocate an available resource within the server group. In still even another embodiment, a transmitter on the power management console 222 transmits the generated command to the at least one power management agent 220.

In one embodiment, an agent in the power management controller 206 generates a command to at least one power management agent 220 to relocate at least one user session from a first server 106a in the server group to a second server 106b in the server group. In another embodiment, a transmitter on the power management console 222 transmits the generated command to the at least one power management agent 220 to relocate the at least one user session from a first server 106a in the server group to a second server 106b in the server group. In still another embodiment, an agent in the power management controller 206 generates a command to the power management agent 220 associated with the first server 106a to power down the first server 106a in the server group. In still even another embodiment, a transmitter on the power management controller 206 transmits the generated command to the power management agent 220 associated with the first server 106a to power down the first server 106a in the server group. In yet another embodiment, a user session may be relocated to a server 106 that consumes a lower level of power.

The power management controller 206 consolidates, onto at least one server in the server group, the subset of the plurality of user sessions (318). In one embodiment, the agent in the power management controller 206 generates a command for at least one power management agent 220 to consolidate, onto at least one server 106 in the server group, the subset of the plurality of user sessions. In another embodiment, a transmitter on the power management controller 206 transmits the command to the at least one power management agent 220 to consolidate, onto the at least one server 106 in the server group, the subset of the plurality of user sessions.

In one embodiment, using the methods and systems described herein results in the generation of a power management schedule 212 applicable to each of a plurality of servers 106 and generated responsive to an attribute—such as a level of load or performance metric—of each of the plurality of servers 106. In another embodiment, using the methods and systems described herein results in a plurality of servers 106 identified as providing users with access to resources having a common session type—for example, providing users with access to resources placing substantially similar levels of load on servers 106 or to resources within sessions having substantially similar access times or length of access time—and in which a plurality of users sessions are consolidated onto the plurality of servers 106.

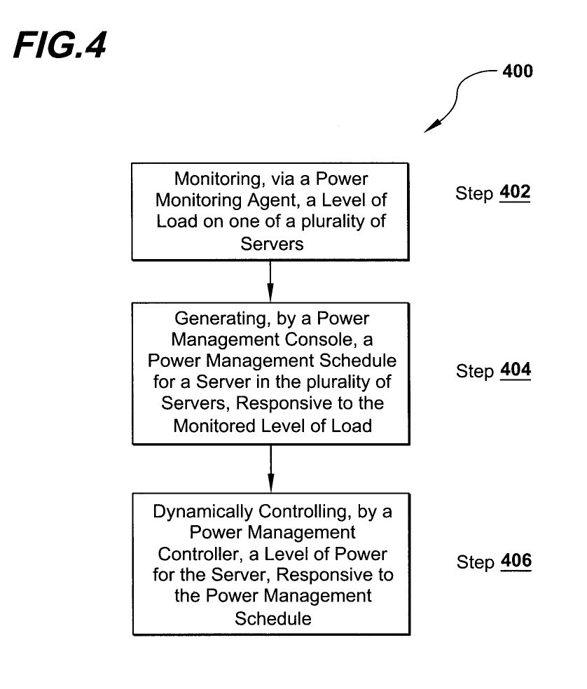

Referring now to FIG. 4, a flow diagram depicts one embodiment of the steps taken in a method 400 for reducing energy consumption by dynamically managing power modes for a plurality of servers. In brief summary, the method includes monitoring, via a power monitoring agent 220, a level of load on one of a plurality of servers (402). The method includes generating, by a power management console 222, a power management schedule 212 for a server in the plurality of servers 106, responsive to the monitored level of load (404). The method includes dynamically controlling, by a power management controller 206, a level of power for the server 106, responsive to the power management schedule 212 (406).

Referring now to FIG. 4, and in greater detail, a power monitoring agent 220 monitors a level of load on one of a plurality of servers 106 (402). In one embodiment, a power management agent 220 monitors a plurality of performance metrics on one of a plurality of servers 106. In another embodiment, the power management agent 220 determines a level of load for the one of the plurality of servers 106, based on the monitored plurality of performance metrics. In still another embodiment, the power management agent 220 determines a level of load for at least one user session on the one of the plurality of servers 106. In still even another embodiment, the power management agent 220 provides the monitored level of load to at least one of the power management console 222 and the power management controller 206. In yet another embodiment, the power management agent 220 provides load information to at least one of the power management console 222 and the power management controller 206. In still even another embodiment, the power management agent 220 is in communication with a monitoring agent 144,197 604, a client agent 120, or a server agent 824, providing the monitored level of load or load information.

The power management console 222 generates a power management schedule 212 for a server 106 in the plurality of servers 106, responsive to the monitored level of load (404). In one embodiment, the power management console 222 receives the monitored level of load from the power management agent 220. In another embodiment, the power management console 222 receives load information from the power management agent 220. In still another embodiment, the power management console 222 determines the level of load based on the load information. In still even another embodiment, the power management console 222 dynamically generates a power management schedule 212 for a server 106 in the plurality of servers 106, responsive to the monitored level of load. In still yet another embodiment, the power management console 222 selects a power management schedule 212 from at least one power management schedule 212 stored in the storage device 290.

In one embodiment, the power management console 222 provides an interface 224 to a user. In another embodiment, the power management console 222 displays, via the interface 224, the monitored level of load or the received load information to the user. In still another embodiment, the user defines a power management schedule 212 for a server 106 in the plurality of servers 106. In yet another embodiment, the user selects a power management schedule 212 from at least one power management schedule 212 stored in the storage device 290. In still even another embodiment, the power management console 222 retrieves a power management schedule 212 from the storage device 290, responsive to the user selecting a power management schedule 212 from at least one power management schedule 212 stored in the storage device 290.

In one embodiment, a user can manually override or update the power management schedule 212, via the interface 224. For example, the user can use the interface to direct a server 106 to power down immediately, power down gracefully or power up. In another embodiment, a user can configure the power management controller 206 to control the level of load or power on a server 106 via the interface 224. For example, the user can define a sequence for servers 106 within a server group to be powered down or powered up in accordance with the power efficiency of each of the servers 106. In still another embodiment, a server 106 that uses more energy relative to their performance may be shut down before other servers in the server group. In some embodiments, the power management schedule 212 is generated as described above in connection with FIGS. 2 and 3.

The power management controller 206 dynamically controls a level of power for the server 106, responsive to the power management schedule 212 (406). In one embodiment, the power management controller 206 dynamically controls a level of power for the server 106, responsive to a change in the level of load. In another embodiment, the power management controller 206 dynamically modifies the power management schedule for a server 106 in the plurality of servers, responsive to the monitored level of load. In still another embodiment, the agent in the power management controller 206 generates a command to a power management agent 220 to dynamically control a level of power for the server 106. In yet another embodiment, the transmitter in the power management controller 206 transmits the command to a power management agent 220 to dynamically control a level of power for the server 106.

In one embodiment, the power management console 222 includes a default server selection algorithm to determine whether to commission or decommission a server 106 while maximizing power savings. In another embodiment, the default server selection algorithm is based on a capacity-per-watt metric for each of the plurality of servers 106. In still another embodiment, a nominal ranking value is assigned to each server 106, so that, for example, a server 106 with a higher ranking value may be powered on before servers 106 of lower ranking. Conversely, a lower ranked server 106a can be powered off before higher ranked servers 106b. For example, to avoid thermal hotspots in a data center blade enclosure that includes a plurality of blade servers 106, each of the blade servers 106 may be assigned a round-robin ranking according to physical position; this can reduce the likelihood that any one blade server 106 is excessively powered on relative to other blade servers 106 in the enclosure. In another embodiment, ranking can be applied to a plurality of blade enclosures to further reduce thermal hotspots between blade enclosures.

In one embodiment, an administrator can apply ranking to control and balance power distribution across a plurality of power distribution units (PDUs). In another embodiment, a plurality of servers 106 may be assigned a default ranking. In still another embodiment, the server selection algorithm randomly selects one of a plurality of servers 106 having the same ranking value to power up or down. In yet another embodiment, the default server selection algorithm can be modified, such as by combining capacity-per-watt metric with ranking, or any other combination of metrics, to drive the server selection.

In one embodiment, user session requests may be queued against one or more servers 106, for example to prevent spreading user sessions across a plurality of servers 106 during periods of high request rates. In another embodiment, user profiling may be applied to predict how long a user may maintain a user session; this data can, for example, be used to direct potentially long-lived sessions to base load servers 106. In still another embodiment, to allow for greater opportunity to consolidate or migrate user sessions, graceful shutdown of servers 106 may be preferred to minimize any loss of data.

In one embodiment, user session consolidation operates in conjunction with a load balancing system. In another embodiment, user session consolidation is performed by manipulating the load balancing system. For example, the power management console 222 may send a command to modify the load value (but not the actual level of load) for one or more servers to influence load balancing decisions by the load balancing system. In still another embodiment, a failsafe approach involves disengaging user session consolidation if a failure is detected, so that normal load-balancing can resume. For example, if a power management agent 220 for a server 106 detects that the power management controller 206 is no longer available (for example, when the connection is lost), the power management agent 220 assumes the server 106 is no longer managed for power reduction, and triggers an automatic failsafe procedure to revert the load value on the server 106.

In one embodiment, fault tolerance features may include the ability to manually disengage the load consolidation functionality to at least one server 106 and/or at least one user sessions. If there is a fault with the control of one particular user session, this user session can be disengaged independently of the others. For example, if a server 106 reports an erroneous load or capacity value that is affecting the dynamics of the user session consolidation, an administrator can manually disengage the server 106 or the associated user sessions from the user session consolidation process.

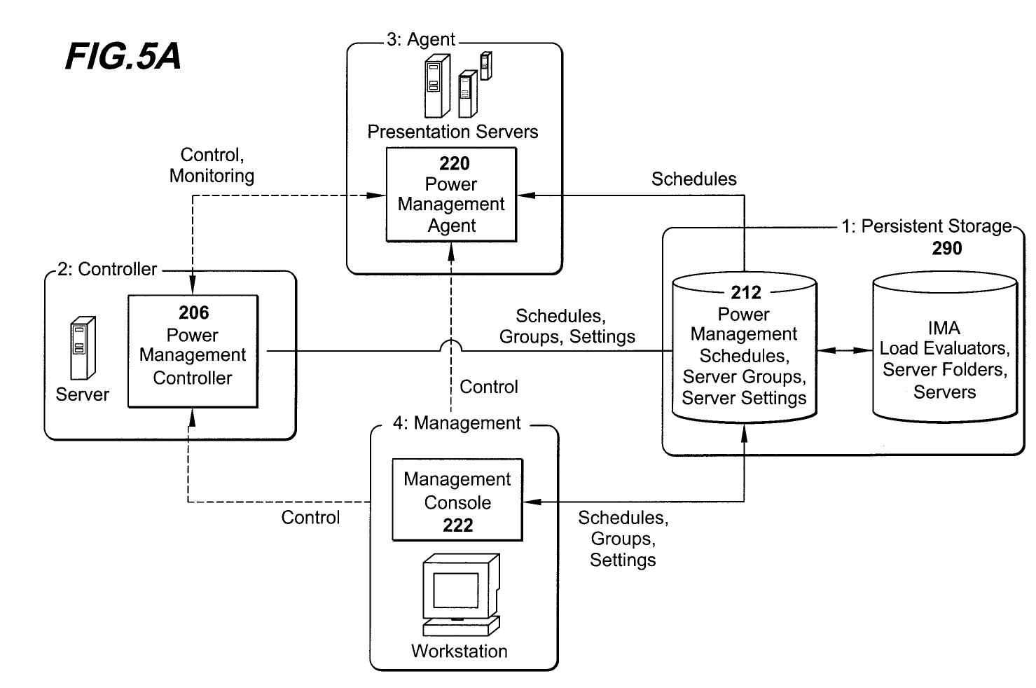

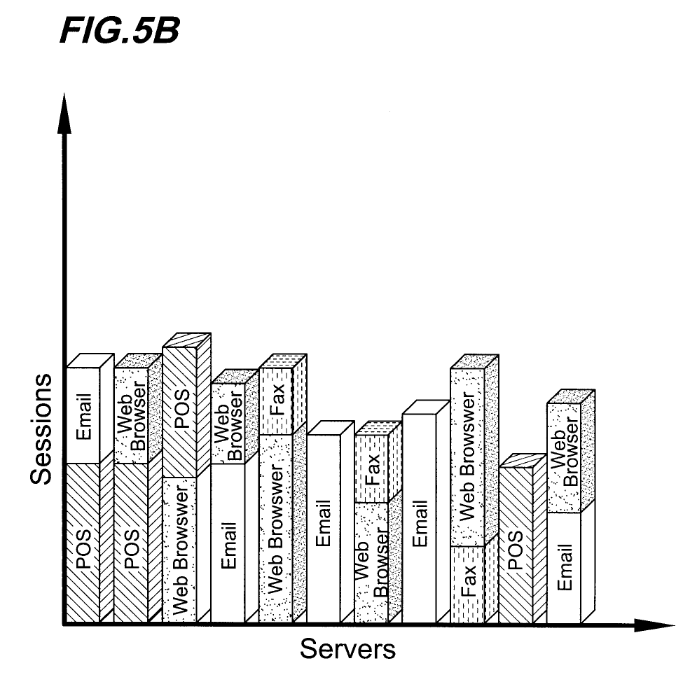

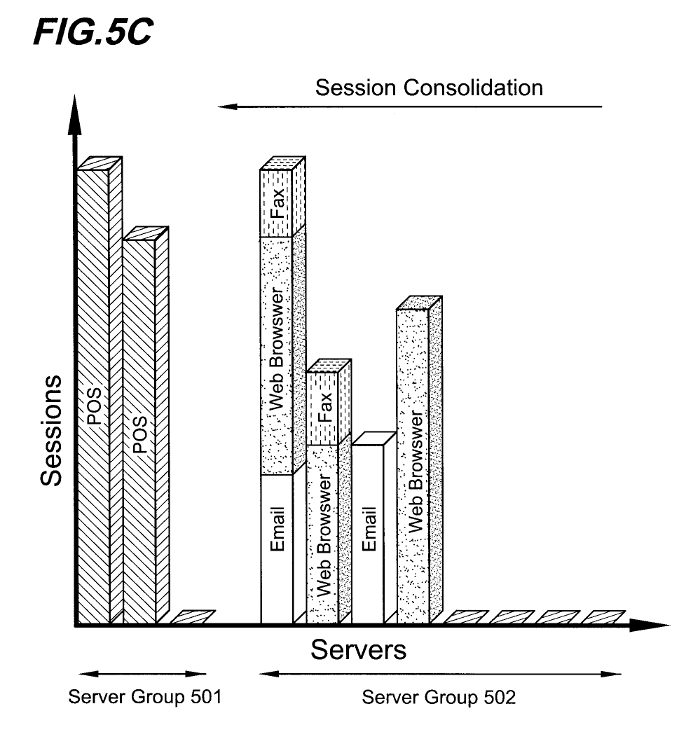

Referring now to FIG. 5A, a block diagram depicts one embodiment of a system for reducing energy consumption in a server farm 38. In brief overview, the system includes a power management agent 220 on each of the plurality of servers 106, a power management console 222, a power management controller 206, and a persistent storage 290 storing a power management schedule 212.

Referring now to FIG. 5A, and in greater detail, the system may include virtual machines that execute on the plurality of physical servers 106. In one embodiment, a single physical server 106 may provide access to at least one virtual machine. A server 106 can terminate a virtual machine executing on the server 106 and save the state of the virtual machine to a disk. In another embodiment, the remote presentation system may migrate, in real-time, a running virtual machine from a first physical server 106a to a second physical server 106. Such capabilities can be leveraged to consolidate virtual machines or virtual servers onto a smaller number of physical servers 106 to reduce energy consumption in the server farm 38.

In one embodiment, the server 106 can serve at least one of a desktop session and an individual application session, to a remote client 102. In another embodiment, the server 106 may be powered down when the server 106 is not providing any user sessions to a client 102.

In one embodiment, a plurality of server groups may be defined and associated with a plurality of session types. For example, a plurality of server groups may be defined to consolidate user sessions of different session length or session load. In another embodiment, long lived or persistent applications may be consolidated onto a first subset of the plurality of servers 106 that are the last to be powered down. In still another embodiment, resources which users access for shorter periods of time may be consolidated onto a second subset of the plurality of servers 106. In yet another embodiment, a session type may also be referred to as an application or session silo.

In one embodiment, a plurality of server groups may be defined in the power management console 222 to consolidate user sessions of different levels of load. In another embodiment, a level of load may be determined by a power management agent 220 based on at least one performance metric associated with a user session. For example, a user session related to a point-of-sale (POS) software application, such as a transaction application used by a sales representative, may be characterized as having a high level of load throughout a typical business day. In still another embodiment, a plurality of server groups may be defined to consolidate user sessions associated with different usage patterns. For example, a user session related to an email client may be characterized by periodic load or activity throughout a day. In yet another embodiment, a user session related to a fax software application or a web browser may be characterized by ad-hoc usage levels.

In one embodiment, the power management agent 220 of each server 106 communicates session characteristics and load information to the power management console 222 of the system. In another embodiment, the power management console 222 determines the session type for each user session, based on the received session characteristics and load information. In still another embodiment, the power management console 222 provides a user interface 224 through which a user can define the plurality of server groups, as well as a power management schedule 212 for each of the plurality of server groups.

In one embodiment, servers 106 substantially optimized to provide user sessions of a session type are allocated to a server group providing user sessions of the session type. In another embodiment, the power management controller 206 operates, in conjunction with a load balancing system, to consolidate user sessions of the session type onto a plurality of servers 106 in the server group. For example, point-of-sale software applications may be consolidated onto a server group 501 optimized for high levels of load. In still another embodiment, since the point-of-sale software applications are typically active and operational during business hours, some of the plurality of servers 106 may power down after business hours to reduce energy consumption.

In one embodiment, applications such as web browsers and fax software, may for example, can be consolidated into a server group 502 comprising servers with lower processing power and capacity. In another embodiment, the ad hoc usage pattern associated with such applications can be a significant characteristic for determining consolidation strategies for reducing energy consumption. For example, the servers providing such user sessions may be selected for being very power efficient while in sleep mode, and can recover quickly from sleep mode to operational mode in response to a session request.

Referring now to FIG. 5B, a chart depicts an embodiment of session loading across a plurality of servers 106 using a typical load balancing approach. In one embodiment, a typical load balancing approach distributing user sessions across all servers may reduce the opportunity for power saving. In another embodiment, different user sessions of different session types may be distributed substantially evenly across a plurality of servers 106. In still another embodiment, none of the servers are powered-down, and very few servers may qualify to be placed in a low-power sleep mode. In yet another embodiment, one or more of the servers 106 may not be substantially optimized to minimize power consumption while providing the user sessions. In still even another embodiment, power consumption overhead may occur even on servers 106 with low levels of load and may not be reduced further or avoided unless the servers 106 are placed in sleep mode or powered down.

Referring now to FIG. 5C, a chart depicts an embodiment of session loading across a plurality of servers 106 resulting from a power-saving session consolidation process. In brief overview, a plurality of servers 106 are divided into two server groups 501, 502, each of the server groups dedicated to providing user sessions of a specific session type.

In one embodiment, point-of-sale software application sessions (e.g., persistent application sessions associated with high levels of load) are consolidated into the first three servers forming a first server group 501. In another embodiment, user sessions related to fax software, email clients and web browsers (i.e., application sessions associated with low levels of load and/or ad-hoc usage patterns) are consolidated onto eight servers forming a second server group 502. In still another embodiment, new user sessions are provided from servers 106 from left to right, resulting in a higher probability of servers 106 on the right side to be idle. In yet another embodiment, new user sessions are provided by the leftmost server 106 of each server group until the server 106 reaches capacity or falls below a service level. In still even another embodiment, idle servers, especially the rightmost servers in each server group, may be candidates for power savings by placing in low-power mode or powering down. In still yet another embodiment, the temporal nature of user sessions, such as the length and load profile of the user sessions, can thus facilitate the consolidation process of new user sessions for power reduction.

In one embodiment, some of the active servers 106a may be powered down to conserve energy when the user sessions they provide can be migrated to other servers 106b without exceeding service limits. In another embodiment, a server 106a may re-direct session requests from one or more clients to other servers 106b in preparation to go into power-saving mode. In still another embodiment, the server 106a does not provide new user sessions and waits for existing sessions on the server 106a to end before powering down. In yet another embodiment, the system may migrate virtual machine sessions, in real-time, from a first server 106a to a second server 106b, or replace a user's inactive desktop session with another desktop session on a second server 106b.

In one embodiment, a power-saving consolidation system can operate in conjunction with a load balancing system, as a combined system, to apply service limits on the servers 106 while achieving power savings. In another embodiment, evaluation of load against these service limits may affect how new user sessions are load balanced across each server group and whether to commission new servers out of power-saving modes. For example, load evaluators of a traditional load balancing system may be adapted to operate with the present system to consolidate user sessions and schedule servers 106 for off-peak periods. In still another embodiment, such a combined system can allow user sessions to be spread across a plurality of servers 106 in order to achieve optimal performance for each session and to achieve the consolidation goal.

In one embodiment, the combined system may set both upper and lower thresholds for service limits to prevent the combined system from oscillating around a single threshold. As an illustration, and in one embodiment, a consolidation scheme may have a single service limit threshold set for a first server 106a such that a second server 106b will be powered up to provide new user sessions if the level of load on the first server 102a exceeds the threshold. If the level of load on the first server 106a fluctuates around the threshold and the level of load of new sessions are low, the second server 106b may powered up and down in tandem with the fluctuations, leading to operational and energy inefficiency. In contrast, if upper and lower thresholds for service limits are set to span a substantial portion of the fluctuations in the level of load, the second server 106b can remain powered-down or powered-up for longer periods of time. In some embodiments, this pattern of powering up and down is referred to as hysteresis.

In one embodiment, as users log off, for example after business hours, an increasing number of servers 106 can be powered down to conserve energy. In another embodiment, as more users requests new user sessions, for example during peak periods, additional servers 106b can be powered up as the level of load on active servers 106a reaches the upper thresholds of their service limits. In still another embodiment, a power management agent 220 on each server 106 can transmit load information to a power management console 222 and a power management controller 206 so that any dynamic allocation of resources, such as servers 106 to provide new user sessions, can be made. In yet another embodiment, the power management agent 220 on each server 106 can transmit updated load information to the power management console 222 and the power management controller 206 for updating the power management schedule 212 and/or dynamically adjusting the number of active servers to handle the number of user sessions. In still even another embodiment, the power management console 222 and the power management controller 206 can monitor the load pattern over time and preemptively start servers 106 before they are required in order to reduce the delay associated with provisioning a new server 106.

In one embodiment, the systems and methods described herein may be used for adaptively load balancing virtual machines executing on a plurality of servers 106 to reduce energy consumption. Referring again to FIG. 2, in an embodiment, the method includes identifying a virtual machine session type for each of a plurality of virtual machines. The method includes defining a server group providing access to a subset of the plurality of virtual machines having a common virtual machine session type. The method includes defining a power management schedule 212 for the server group. The method includes consolidating, onto at least one server 106 in the server group, the subset of the plurality of virtual machines. In one embodiment, the method includes receiving, from a power management agent 220, information identifying a virtual machine session type for at least one of the plurality of virtual machines. In another embodiment, the method includes defining a server group including at least one server substantially optimized to provide virtual machine sessions of the common virtual machine session type. In another embodiment, the method includes monitoring, by a power management agent 220, a change in a level of load.

In one embodiment, the method includes dynamically modifying the power management schedule 212 for the server group, responsive to a change in a level of load. In another embodiment, the method includes dynamically allocating an available resource within the server group. In still another embodiment, the method includes relocating at least one of the subset of the plurality of virtual machines from a first server 106a in the server group to a second server 106b in the server group. In still even another embodiment, the method includes powering down the first server 106a in the server group. In yet another embodiment, the method includes powering up a virtual machine. In still yet another embodiment, the method includes powering down a virtual machine.

In some embodiments, the systems and methods described herein may be provided by a power control system (PCS). In one embodiment, a power control system controls a plurality of servers 106 providing a user session of a particular session type. In another embodiment, the plurality of servers 106 may include an application server, a desktop server, a virtual server 275, or a web server. In still another embodiment, the power control system may manage at least one CITRIX PRESENTATION server, CITRIX XENAPP server, or CITRIX XEN DESKTOP server.

In one embodiment, a power control system includes all of the components described above in connection with FIG. 2. In another embodiment, a power control system manages a plurality of servers 106 at a plurality of sites. In still even another embodiment, the power control system controls a plurality of servers 106 such that a minimum number of servers 106 are powered up to provide the user sessions while maintaining required service levels. In yet another embodiment, a power control system improves server utilization and reduces energy consumption compared to maintaining the plurality of servers 106 powered up all the time or for extended periods of time.

In one embodiment, a power control system is a closed-loop control system that monitors the load and capacity of a plurality of servers 106. For example, in another embodiment, the monitored load and server capacity are used as feedback in the power control system to drive available capacity to meet desired service level requirements by controlling the number of servers 106 for handling a plurality of user sessions. In still another embodiment, a power control system controls the plurality of servers 106 based on a plurality of setpoint parameters. In yet another embodiment, the plurality of setpoint parameters specifies a desired level of capacity in relation to a level of load on the plurality of servers 106. In still even another embodiment, the plurality of setpoint parameters represents the service level thresholds derived from a service level agreement (SLA), for example.

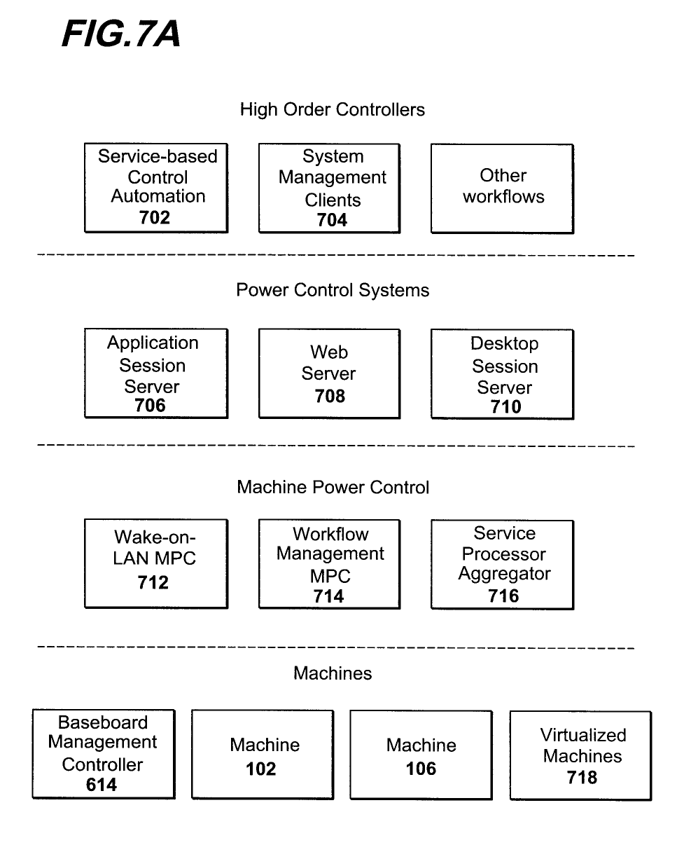

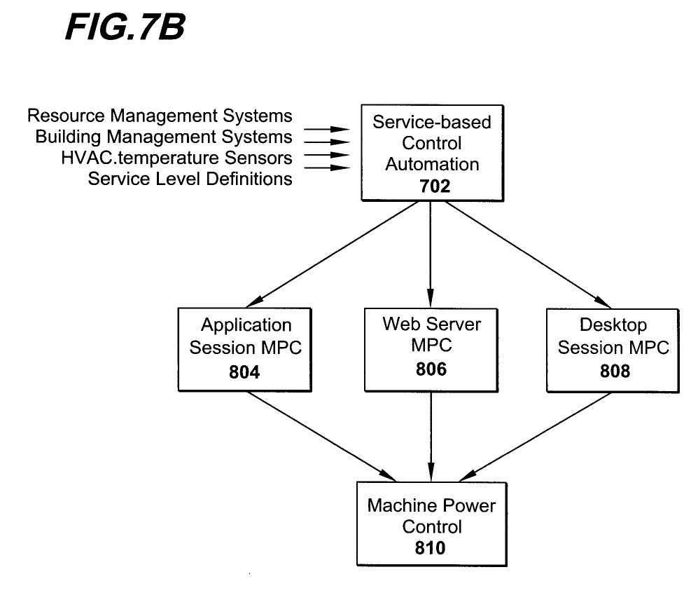

In one embodiment, the setpoint parameters are maintained by any number of external entities including administrators, workflows, automation scripts, schedules, or higher-order control systems such as a service-based control automation (SBCA) system, described below in connection with FIGS. 7A and 7B.

In one embodiment, the service-based control automation system provides resource management by balancing available hardware resources between different workload types. In another embodiment, the service-based control automation system may provide automated provisioning, for example via CITRIX PROVISIONING SERVER. In still another embodiment, the service-based control automation system can receive input from sources such as temperature sensors, power distribution unit sensors and other management systems. In yet another embodiment, the service-based control automation system is in communication with a monitoring system such as the CITRIX EDGESIGHT system, to report on power and cost savings.

In one embodiment, the power control system provides failover from servers 106 in the primary data center to a data recovery site. In another embodiment, during normal operation all servers 106 in the data recovery site are left on standby power. In still another embodiment, partial failover can occur where some servers are unavailable or where there is insufficient capacity to meet the number of user session requests. In yet another embodiment, a complete failover of the data center may require a redundant power control system in the data recovery site to take control of the data recovery servers. In still even another embodiment, a partial failover may require a primary power control system to continue to manage local servers while spilling over excess capacity to servers in the remote data recovery site. In yet another embodiment, the primary power control system communicates, to the redundant power control system, the additional capacity required to meet a shortfall. In further embodiments, the redundant power control system provides data recovery servers to meet the shortfall, in response to the communication with the primary power control system.

In one embodiment, when service and capacity is restored at the primary data center, user sessions are migrated back to the primary data center. In another embodiment, a rack of redundant servers in the data center may serve as a data recovery site or a spill-over server group. In still another embodiment, a plurality of spill-over server groups may exist within a primary data center or a primary server group. In yet another embodiment, the plurality of spill-over server groups may be ranked for preference in handling capacity spillover.

In one embodiment, the power control system can place a server 106 into low-power “standby” mode when all user sessions provided by the server 106 become disconnected or are identified to be idle. In another embodiment, when a user session becomes active or attempts to reconnect, the server 106 providing the user session will automatically resume an appropriate, higher power level. In still another embodiment, the power control system includes an agent that monitors for user session activity or client reconnection activity.

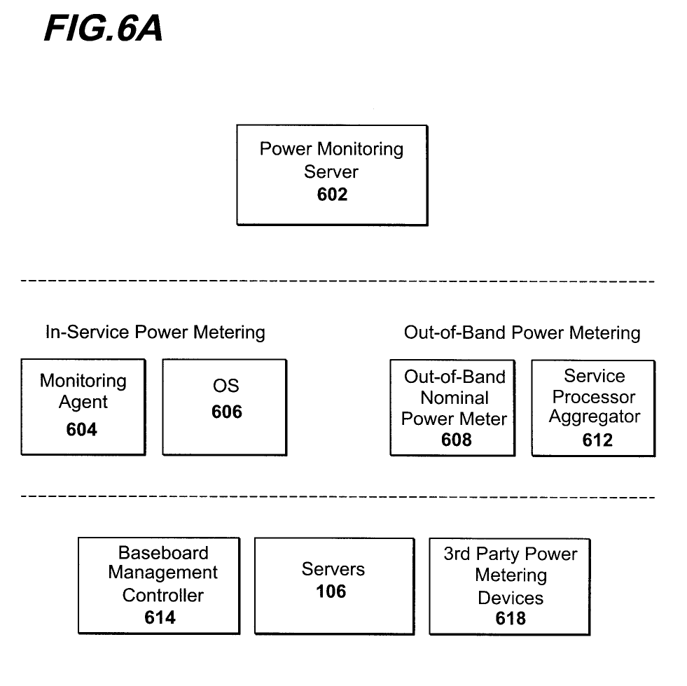

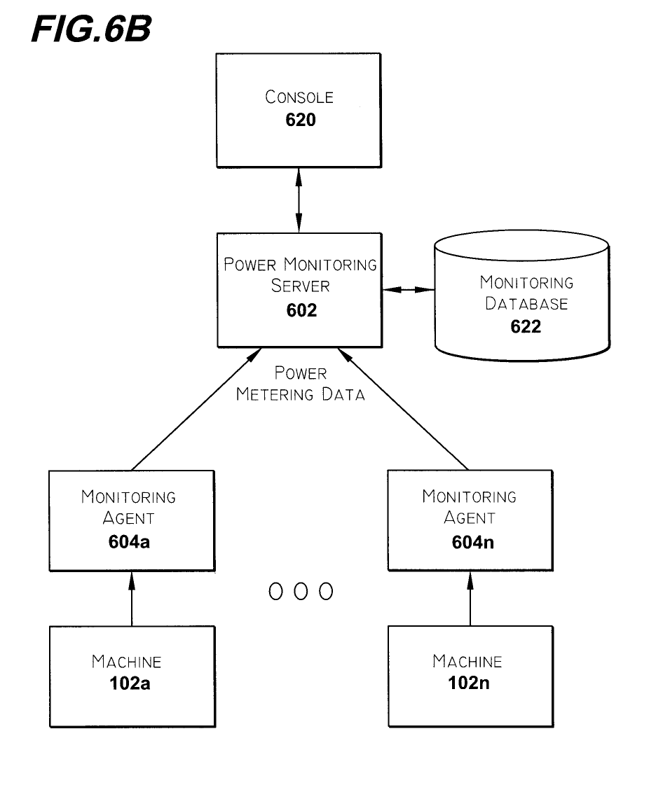

Referring now to FIG. 6A, a block diagram depicts one embodiment of a system for power metering and reporting. In brief overview, the system includes a power monitoring server 602, a monitoring agent 604, an operating system 606 (OS), an out-of-band nominal power meter 608, a service processor aggregator 612, a baseboard management controller 614, a plurality of servers 206, and third-party power metering devices 618.

Referring now to FIG. 6A, and in more detail, the power monitoring server 602 provides monitoring and reporting of power consumption for the system. In one embodiment, the power monitoring server 602 may be a CITRIX EDGESIGHT server. In another embodiment, the power monitoring server 602 is in communication with a console (not shown). In still another embodiment, power consumption may be reported via the console. In yet another embodiment, a level of power associated with a user session may be reported via the console.

Referring now to FIG. 6B, and in one embodiment, the plurality of servers 106 can be homogenous and supported by in-service power metering. In another embodiment, in-service power metering is provided by at least one monitoring agent 604, such as a CITRIX EDGESIGHT agent, in communication with the operating systems 606 of the plurality of servers 106. In still another embodiment, a monitoring agent 604 collects or determines power metrics of a monitored server 106 and sends the power metrics to the power monitoring server 602. In yet another embodiment, the monitoring agent 604 includes functionality provided by a monitoring agent 144, 197, a server agent 824, or a client agent 120 residing in a server 106, a client 102, or a machine.

In one embodiment, the plurality of servers 106 can be heterogeneous, including a range of vendor-specific service processors, hardware platforms and management interfaces. In another embodiment, an out-of-band power meter can support the heterogeneous plurality of servers 106, alone or in combination with in-service metering. In still another embodiment, out-of-band metering is provided by at least one of an out-of-band nominal power meter 608 and a service processor aggregator 612. In yet another embodiment, an out-of-band power meter may be used to monitor the power consumption of a server 106 while in standby mode. In still another embodiment, out-of-band or in-server meter may support virtual servers 275 and virtual machine power metering.

In one embodiment, out-of-band power metering may be required to monitor the power consumption for “bare metal” machines, for example, machines that do not have substantial functionality to communicate in-service with the monitoring agent 604. In another embodiment, power data can be collected from a “bare metal” machine if a baseboard management controller on the machine is powered up.

In one embodiment, where an out-of-band power meter is not available, a nominal power meter 608 can be provided. In another embodiment, nominal power metering involves specifying nominal power consumption values (e.g., in Watts) for each type of server 106, for example, a best estimate of the average power consumption of each type of server 106 when powered up. In yet another embodiment, the nominal power consumption values are specified by an administrator or provided in server specifications. In yet another embodiment, nominal power metering can be useful in providing power estimates and trend analysis.

Referring now to FIG. 7A, a block diagram depicts one embodiment of a system for controlling server consolidation to reduce power consumption including control layers in the system. In one embodiment, the system includes control layers for high order controllers, power control systems, machine power control and machine-level control. In another embodiment, higher order controllers, such as a service-based control automation (SBCA) system 702, dynamically allocates and reallocates resources from a plurality of servers 106 to provide user sessions based on service level policies. FIG. 7B shows one embodiment of inputs to a service-based control automation system 702 and the control flow from the service-based control automation system 702 to the machine power control layer.

In one embodiment, at the power control system layer, each power control system manages a plurality of servers 106 at one site, the plurality of servers 106 may include application servers, desktop servers, web servers, virtual servers, or other types of servers. In another embodiment, a multi-site server farm 38 may have a plurality of power control systems, for example, one power control system for each site. In still another embodiment, interfaces for resource selection and setpoint parameter changes are provided by the power control system to the higher order controllers, such as a service-based control automation system 702. In yet another embodiment, an interface is provided by a power control system to a power management console 222 to administer the power control system. In still even another embodiment, reporting functionalities are performed, for example, via a power management console 222, on a power control system database stored in a storage device 290. In some embodiments, the service-based control automation system 702 is in communication with at least one machine power control.

In one embodiment, a machine power control (MPC) layer includes controls for powering off/on a server 106 and changing the power level of a server 106, for example, placing a server 106 into standby mode. In another embodiment, as described above in connection with FIG. 2, a command is directed to a power management agent 220 to control the power level of a server 106. For example, in one embodiment, the power management agent 220 communicates with the OS to control the power level of a server 106. In another embodiment, remote agent-less control may be implemented with a platform like MICROSOFT WINDOWS Remote Management (WinRM). In still another embodiment, Wake-on-LAN (WOL) controls 712 may be used to activate a server 106 from low-power standby mode. In yet another embodiment, an Intelligent Platform Management Interface (IPMI) may be implemented in a server's service processors or baseboard management system to activate a server 106 from low-power standby mode.

In one embodiment, a workflow solution, such as CITRIX WORKFLOW STUDIO, may be used as an interface for a machine power control to manage consolidation and/or load-balancing of a plurality of servers 106. For example, Wake-on-LAN activity can be controlled within an interface provided by the workflow solution. The workflow solution can also coordinate machine power control activities across a plurality of heterogeneous servers 106 by providing custom interfaces with each type of server 106. In another embodiment, a service processor aggregator 716, such as an AVOCENT MERGEPOINT service processor aggregator, may provide a portion of the workflow solution. In still another embodiment, a service processor aggregator 716 provides an interface for communicating with service control processors from a plurality of vendors. In yet another embodiment, a workflow solution manages at least one of a service-based control automation system, a machine power control and a power control system.

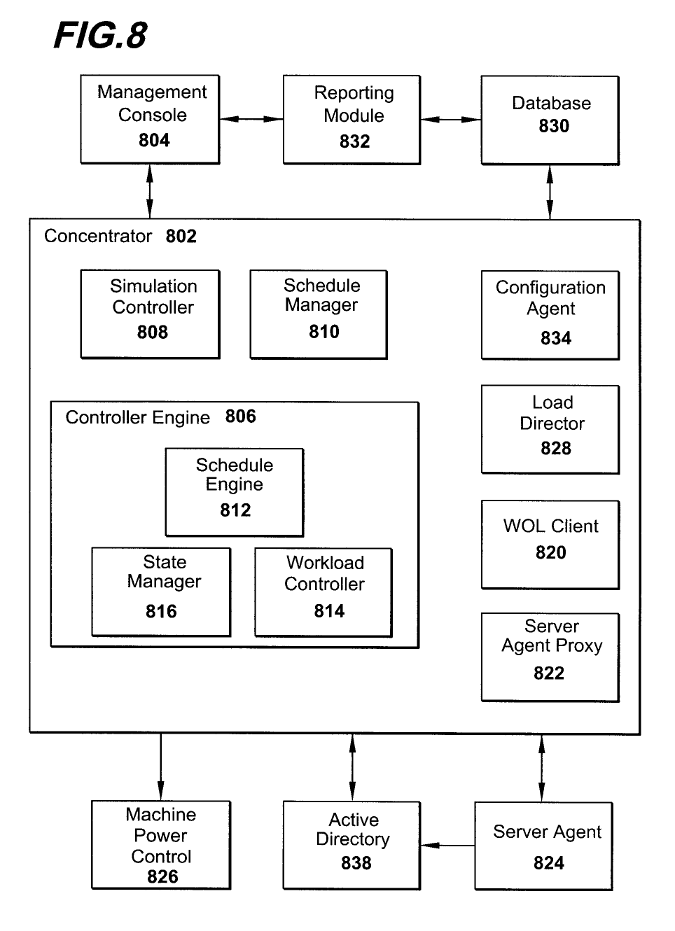

Referring now to FIG. 8, a block diagram depicts one embodiment of a system for reducing energy consumption in a plurality of servers 106. In brief overview, the system includes a concentrator 802, a management console 804, a machine power control 826, a reporting module 832, a database 830, an active directory 838 and a server agent 824. In one embodiment, the concentrator 802 includes a simulation controller 808, a schedule manager 810, a controller engine 806, a wake-on-LAN (WOL) client 820, a load director 828, a configuration agent 834 and a server agent proxy 822. In another embodiment, the controller engine 806 includes a schedule engine 812, a workload controller 814 and a state manager 816.

Referring now to FIG. 8, and in greater detail, the concentrator 802 communicates with at least one server agent 824 associated with a plurality of servers 106, the plurality of servers 106 being power managed to reduce power consumption. In one embodiment, the concentrator 802 communicates with the management console 804 and handles workflow, automation script, and other management and monitoring requests. In another embodiment, the concentrator 802 may be a power management controller 206 as described in connection with FIGS. 2-5.

In one embodiment, the concentrator 802 provides a failover clustering model supporting at least two nodes, i.e., a cluster of two nodes. In another embodiment, one node in the cluster is a master concentrator and all other active nodes will be slave concentrators. In still another embodiment, the synchronization of states between master and slave concentrators in a cluster occurs via a structured query language (SQL) server database. In yet another embodiment, failover support is directed through the SQL server database; each active slave concentrator can continually poll the state of the master concentrator, for example, by observing whether the master concentrator has been actively updating the database. In still even another embodiment, if no updates have been made for a period of time, one of the active slave concentrators may replace the master concentrator and update the database. In still yet another embodiment, database record locking and concurrency management may be used to provide a synchronization mechanism to prevent more than one slave from replacing the master concentrator simultaneously.

In one embodiment, the master concentrator is in communication with a plurality of server agents 824. In another embodiment, when a server agent 824 attempts to connect (or reconnect after failover), the server agent 824 accesses an active directory 838 to identify a list of active concentrators. In still another embodiment, the listening ports of slave concentrators may be closed so as not to connect to the server agents 824. In yet another embodiment, the server agent 824 sequentially attempts to connect with the list of concentrators until a connection is established with the master concentrator.

In one embodiment, the concentrator 802 provides a range of administrative and automation interfaces for configuring the operation of the system, such as interfaces for the management console, scripts (e.g., MICROSOFT POWERSHELL scripts), workflow activities (e.g., CITRIX WORKFLOW STUDIO activities), WinRM, MICROSOFT Visual Studio, MICROSOFT System Center Operations Manager, and other systems management clients. In another embodiment, the concentrator 802 provides a simulation controller interface with the simulation controller 808 for initiating, monitoring and managing simulation control processes in communication with a simulator controller 808. In still another embodiment, the concentrator 802 provides a controller interface for operating a controller engine 806, including providing manual override and control system disengagement directives. In yet another embodiment, the concentrator 802 provides a scheduler interface to the workload controller 814 to manage workload controller schedules.

In one embodiment, the concentrator 802 provides a state management interface to manage and observe the running state of the system, including manipulating workloads and server state. In another embodiment, the concentrator 802 provides a configuration interface for making a change in system-wide configuration settings. In still another embodiment, the concentrator 802 provides a resources interface to control server resources available to the user sessions of a session type.

In one embodiment, the concentrator 802 provides a Wake-on-LAN (WOL) client interface to power on or “wake-up” servers 106 in an environment where power-managed servers 106 support Wake-on-LAN. In another embodiment, the concentrator 802 provides a machine power control (MPC) interface to communicate with an external machine power control 826. For example, this interface may be in the form of an external application, workflow, or script that is capable of waking or powering on a machine, whether a physical bare metal machine or a virtual machine. In still another embodiment, the concentrator 802 provides a machine selector interface for invoking custom-written machine selectors external to the concentrator 802. In yet another embodiment, the concentrator 802 provides a load balancing system interface to track, via the state manager 816, the maintenance state of servers 106. In still even another embodiment, the concentrator 802 provides a SQL server database interface to access the SQL server database 830. In still yet another embodiment, the concentrator 802 provides an active directory 838 to publish a session control protocol (SCP) associated with the concentrator 802.

In one embodiment, the system includes a database 830, for example, a SQL server database, accessed by the concentrator 802 and a reporting module 832. In another embodiment, the database 830 provides the common store of data for a plurality of servers 106 in a server group or server farm 38. In still another embodiment, data stored in the database 830 includes concentrator node registrations, workload definitions, managed servers 106 and workload mappings, managed server power event log files, server profiles and capacity schedule definitions, and utilization and load metrics. In yet another embodiment, the database 830 provides a database interface to provide access to database data via SQL. In still even another embodiment, the database 830 may be stored in a storage device 290.

In one embodiment, the system includes a reporting module 832 providing a set of pre-defined reports. In another embodiment, the reporting module 832 can generate reports of monitored utilization and load metric data in tabular or chart format. In still another embodiment, types of reports available include system-wide utilization reports, system-wide load vs. capacity reports, workload specific utilization reports, workload specific load vs. capacity reports, server specific utilization reports, and server specific load vs. capacity reports. In still even another embodiment, reports may be generated covering different periods and at different granularities (e.g. hourly, daily, weekly) to present server trends and the effect of control system changes. In yet another embodiment, power-related reports can be generated, for example, by populating a report with data collected by a CITRIX EDGESIGHT monitoring system.

In one embodiment, the reporting module 832 accesses the database 830 for information to generate reports. In another embodiment, the reporting module 832 stores reports into the database 830. In still another embodiment, the reporting module 832 provides a reporting interface with a web services front end for executing, displaying or printing reports.

In one embodiment, the concentrator 802 includes a controller engine 806 providing closed-loop power control of managed servers 106 within a server group for each session type. In another embodiment, the concentrator 802 instantiates one controller engine 806 to manage a set of user sessions, with additional instances for each simulation run initiated by the simulation controller 808. In still another embodiment, the controller engine 806 tracks the state of workloads and server groups to maintain sufficient capacity to service demand. In yet another embodiment, the controller engine 806 is controlled with a set of setpoint parameters that is maintained and updated by a schedule engine 812 or by an external agent. In still even another embodiment, each controller engine 806 instance hosts a schedule engine 812 that executes based on schedule definitions managed by a scheduler manager 810. In some embodiments, a controller engine 806 provides functionality of a power management controller 206 as described above in connection with FIGS. 2-5.

In one embodiment, the controller engine 806 includes a workload controller interface for communicating with a workload controller 814. For example, in some embodiments, the controller engine 806 overrides the schedule engine 812 with specific setpoint parameters for each workload, and for disengaging/reengaging the control system. In another embodiment, the controller engine 806 includes a state management interface for monitoring a running state of system, for example, by communicating with the state manager 816 to monitor the user sessions and server states on a server 106. In still another embodiment, the controller engine 806 includes a Wake-on-LAN (WOL) client interface for each controller engine 806 instance to power on or “wake-up” servers 106 in environments that support Wake-on-LAN, via communication with a machine power control 826. In yet another embodiment, the controller engine 806 includes a machine power control (MPC) interface for each controller engine 806 instance to power on or “wake-up” servers 106, for example, to supplement WOL.

In one embodiment, the controller engine 806 includes a load balancing system interface for each controller engine 806 instance, which is used by the state manager 816 for tracking the “maintenance” state of servers 106—a server 106 is in “maintenance” when the server 106 is disabled from accepting new user sessions or is not participating in load balancing. In another embodiment, the controller engine 806 includes a server agent interface allowing a controller engine 806 instance to communicate with a server agent 824, for example, to send a command for the server agent 824 to reduce the amount of capacity provided by a server 106. In still another embodiment, the controller engine 806 may instruct the server agent 824, via the server agent interface, to direct session requests away from a server 106 in preparation to decommission the server 106. In still another embodiment, the controller engine 806 includes a data access layer for accessing the database 830.

In one embodiment, the controller engine 806 includes a workload controller 814. In another embodiment, the workload controller 814 controls a plurality of servers 106 to drive server capacity to particular setpoint levels. In another embodiment, the workload controller 814 selects servers 106 to power up or down for changing session type capacity levels. In still another embodiment, the workload controller 814 may use a selection algorithm based on an amount of capacity change required for a server group, and/or preference and ranking values set against each server 106 in the server group. In still even another embodiment, the selection algorithm can be overridden with a custom implementation invoked via an external application, workflow or script.

In one embodiment, the workload controller 814 includes a schedule control interface, used by the schedule engine 812 to request setpoint parameter changes when a scheduled event occurs, for example, to update a power management schedule 212. In another embodiment, the workload controller 814 includes an external control interface for overriding the schedule engine 812 with specific setpoint parameters and for disengaging/reengaging the control system, for example, for each session type. In still another embodiment, a state manager interface is provided for obtaining the persistent and dynamic state of user sessions and servers 106, including load and capacity, for selecting servers 106 from the server group. In yet another embodiment, a Wake-on-LAN client interface is provided for each workload controller instance to power on or “wake-up” servers 106 in communication with Wake-on-LAN clients in environments where WOL is supported.

In one embodiment, the workload controller 814 communicates with the Machine Power Control 826 and provides a machine power control (MPC) Interface for workload controller instances to power on or “wake-up” machines in communication with a machine power control 826, for example, to supplement WOL. In another embodiment, the workload controller 814 provides a machine selector interface for invoking custom-written server selectors external to the concentrator 802.

In one embodiment, the controller engine 806 includes a schedule engine 812 for initiating setpoint parameter changes to the workload controller 814 when a scheduled time occurs. In another embodiment, the schedule engine 812 interfaces with the schedule manager 810 to obtain schedule definitions. In still another embodiment, a schedule engine 812 can be instantiated and started by each controller engine 806 instance, and remains active in processing schedule events until deactivated.

In one embodiment, the schedule engine 812 provides a schedule control interface and maintained by the workload controller 814 for requesting setpoint parameter changes when a scheduled event occurs. In another embodiment, a schedule manager interface is provided for obtaining schedule definitions and to determine the next scheduled event on which to act.

In one embodiment, the controller engine 806 includes a state manager 816 that monitors the persistent and runtime state of the user sessions, servers 106 and other objects in the system. In another embodiment, the state manager 816 instance executes as part of a controller engine 806 instance. In another embodiment, in a simulated controller engine, a state manager 816 instance is duplicated from an active (“live”) controller engine's state manager 816. In still another embodiment, the state manager 816 instance may be disassociated from the database 830 and other discovery mechanisms. In still even another embodiment, when a simulation run is complete, the simulation controller 808 deactivates the associated controller engine and state manager instances. In yet another embodiment, the metadata related to a simulation run and the metric data collected during the simulation run can be analyzed using the database's reporting facility.

In one embodiment, a persistent state of a server group is synchronized with the database 830 and the runtime state is derived from external sources, such as emulated inputs.

In another embodiment, the persistent state includes user session and session type definitions, server identities with associated control mode setting, preference group, ranking, associated server profile and associated workload. In still another embodiment, the persistent state includes recent power action requests and results for each server 106, and server profiles and associated capacity settings. In still even another embodiment, the runtime state includes current server farm load and capacity metrics and current user session load and capacity metrics. In yet another embodiment, the runtime state include current server load and capacity metrics, server power on/off state, and server maintenance mode state.

In one embodiment, while a simulation is actively running, the persistent state for the simulation may be fixed. In another embodiment, the state manager 816 is not affected by changes to the database 830 and the runtime state is driven by emulated inputs. In still another embodiment, all concentrator nodes in a cluster can maintain, via the corresponding state managers 816, the persistent state. In still even another embodiment, the master concentrator manages the runtime state via the state manager 816 in the master concentrator. In yet another embodiment, if there is a failover and a change in master concentrator, the new master concentrator can attempt to resynchronize the runtime state via the state manager 816 in the master concentrator. In still yet another embodiment, a period of time may be required for a plurality of server agents 824 to reconnect to the new master concentrator and for the persistent and/or runtime state to be re-established.

In one embodiment, the state manager 816 provides a state management interface for accessing persistent and runtime state, and setting persistent state values. In another embodiment, the state manager 816 provides a resource management interface to enable a server agent 824 to register, deregister and update various state values associated with a server 106. In still another embodiment, the state manager 816 provides a load balancing system interface to track the “maintenance” state of servers 106. In yet another embodiment, the state manager 816 provides a data access layer for synchronizing persistent state with the database.

In one embodiment, a simulation controller 808 in the concentrator 802 instantiates and manages simulation runs upon request. In another embodiment, an instance of the controller engine 806 is created for each simulation. In still another embodiment, the results of a simulation are stored in the database 830 and controller engine 806 instance is deactivated after the simulation. In still even another embodiment, the simulation controller 808 may allow multiple simulations to run concurrently. In yet another embodiment, a simulation is used to analyze data monitored by a server agent 824. In another embodiment, a simulation may provide data to make predictions or provide recommendations to update power management schedules 212. For example, a simulation may provide results that predict a higher level of load at 9 a.m. compared with 5 a.m., and recommends changing the power management schedule 212 to power up more servers 106 at 8.30 a.m. to handle the higher level of load.

In one embodiment, each instance of a controller engine 806 corresponding to a simulation creates an instance of the schedule engine 812, the state manager 816, and the workload controller 814. In another embodiment, a controller engine 806 instance, whether live or simulated, shares a common group of schedule definitions via the schedule manager 810.

In one embodiment, the simulation controller 808 provides a simulation interface for initiating, monitoring and managing simulation runs. In another embodiment, the simulation controller 808 provides a controller engine interface for creating and managing simulation controller engine 806 instances. In still another embodiment, the simulation controller 808 provides a data access layer for storing simulation metadata to the database 830.

In one embodiment, a schedule manager 810 in the concentrator 802 provides workload schedule definitions for use by a schedule engine 812 instance within each controller engine 806 instance, for both live and simulated controller engines 806. In another embodiment, schedules are stored in the database 830, mapped against user sessions, and define schedule items for setpoint parameters change events. In still another embodiment, a server group of a session type without a schedule is essentially an unmanaged server group and will not be power-controlled by the system. In yet another embodiment, the schedule manager 810 includes modules for creating, modifying, and deleting schedules. In still another embodiment, the schedule manager 810 allows schedules to be duplicated for use with other server groups.

In one embodiment, the schedule manager 810 provides a scheduler interface for managing schedule definitions. In another embodiment, the schedule manager 810 provides a controller engine interface for creating and managing simulation controller engine 806 instances. In still another embodiment, the schedule manager 810 provides a data access layer for retrieving and manipulating schedule definitions in the database. In yet another embodiment, the schedule manager 810 may provide functionality for a power management console 222 or a power management controller 206 as described in connection with FIGS. 2-5.

In one embodiment, the concentrator 802 includes a configuration agent 834 that manages system-wide configuration settings. In another embodiment, changes to configuration settings are applied to the database 830 and shared with other concentrator 802 instances in the cluster. In still another embodiment, concentrator instance-specific settings may be written to a registry. In yet another embodiment, the configuration agent provides a configuration interface for changing system-wide configuration settings. In still even another embodiment, the configuration agent 834 provides a data access layer for retrieving and manipulating configuration settings in the database 830.

In one embodiment, a concentrator 802 includes a load director 828 to modify the default behavior of a load balancer to achieve user session consolidation. In another embodiment, the load director 828 provides a module that modifies the load state for each server 106 in each server group to direct new user sessions to be provided from servers 106 that have not reach their capacity. In still another embodiment, the load director 828 sends a command to at least one server agent 824 to modify the load state of the servers 106. In yet another embodiment, this process may be referred as load modulation.

In one embodiment, for each workload, the process of power controlling servers 106 in the server group may operate independently from the load director 828. In another embodiment, for example, a server group can have its servers 106 power-controlled while the user sessions are not consolidated—such as when the server group includes critical performance criteria in which user session consolidation poses a risk. Conversely, user sessions provided by a plurality of servers 106 may be consolidated onto at least one server 106 of a server group while power controlling the servers 106.

In one embodiment, the load director 828 operates based on concentrator configuration settings maintained by the configuration agent 834. In another embodiment, the load director 828 provides a state management interface for obtaining server group definitions and server states, including load information collected from a server agent 824. In still another embodiment, the load director 828 provides a server agent interface for initiating load modulation requests, via at least one server agent 824, to a plurality of servers 106.

In one embodiment, the concentrator 802 includes a Wake-on-LAN client 820 for powering on or “waking-up” servers 106, as directed by the workload controller 814. In another embodiment, Wake-on-LAN (WOL) is the default mechanism to power on a server 106. In still another embodiment, an override for the default mechanism is provided in the configuration settings by an external machine power control 826 (MPC), workflow, script or application. In yet another embodiment, the Wake-on-LAN Client 820 provides a Wake-on-LAN client interface to power on or “wake-up” a server 106 from standby mode when provided with the server's media access control (MAC) address and/or internet protocol (IP) address. In still even another embodiment, the Wake-on-LAN Client 820 provides a network interface for transmitting Wake-on-LAN packets. In still another embodiment, the Wake-on-LAN Client 820 communicates, via a server agent proxy 822, with a server agent 824 to power on or “wake-up” a server 106.

In one embodiment, the concentrator 802 includes a server agent proxy 822 that acts as an intermediary for requests to server agents 824. In another embodiment, incoming requests may include server registrations and server state changes. In still another embodiment, outgoing requests from the workload controller 814 may include a request to allow existing user sessions to complete/terminate on a server 106 followed by the powering down of the server 106. In yet another embodiment, outgoing requests from the load director 828 include a request to modulate load on a plurality of servers 106.

In one embodiment, a server agent proxy 822 publishes a concentrator node in an active directory 838, as a service connection point (SCP) that includes address and binding information. In another embodiment, the server agent proxy 822 accepts connection requests with server agents 824 when the concentrator 802 is the master concentrator.

In one embodiment, the server agent proxy 822 provides a server agent interface for communications with at least one server agents 824. In another embodiment, the server agent proxy 822 provides a server agent proxy interface for concentrator components, such as the load director 828, to forward requests to a server agent 824. In still another embodiment, the server agent proxy 822 provides a resource management interface maintained by the state manager 816 for forwarding registration requests and server state change events from a server agent 824.

In one embodiment, the system includes at least one server agent 824, each server agent 824 executing on each server 106 managed by the system. In another embodiment, a server agent 824 registers a server 106, monitors various server state variables and acts on requests issued by the concentrator 802. In still another embodiment, the server agent 824 may include functionality provided by a CITRIX EDGESIGHT agent, a power management agent 220, a monitoring agent 144, 604, or a client agent 120, and may reside in a machine, server 106 or client 102. In yet another embodiment, a server agent 824 identifies the server agent's concentrator endpoint (or cluster of concentrators) by querying a session control protocol (SCP) in an active directory 838.

In one embodiment, a server agent 824 may report a change in state, such as a change in load or in the number of sessions provided by the server 106, to the concentrator 802. In another embodiment, the server agent 824 can respond to concentrator requests to modulate load, or to prepare to decommission a server 106. In still another embodiment, if a connection to a master concentrator is lost, such as when a slave concentrator takes over as the master concentrator, the server agent 824 may failover to other concentrators that have published their endpoints in an active directory 838. In yet another embodiment, when a server agent 824 loses a connection with the concentrator 802, the associated server 106 becomes unmanaged and the server agent 824 relinquishes control of the server 106 and undoes any load balancing changes that the server agent 824 has made to the server 106.

In one embodiment, the server agent 824 provides an agent interface to allow a master concentrator to make requests to the server agent 824. In another embodiment, this interface operates when a dual communication channel is established between the server agent 824 and the concentrator 802. In another embodiment, the server agent 824 provides a server agent interface for registering a server 106 and notifying state changes and changes in session type to a concentrator 802. In still another embodiment, the server agent 824 provides a load balancing system interface for tracking state variables for a server 106. For example, a state variable may indicate whether a server 106 is in maintenance and another state variable may include information on the current load. In yet another embodiment, the server agent 824 publishes a concentrator session control protocol (SCP) in an active directory 838.

In one embodiment, the system includes a management console 804 for administering and monitoring the state of the system via the concentrator 802. In another embodiment, the management console 804 may include modules for simulation management, controller management, schedule management, state management and monitoring, system-wide configuration, and reporting. In still another embodiment, the management console 804 provides a simulation controller interface for initiating, monitoring and managing simulation control processes. In yet another embodiment, the management console 804 provides a controller interface for controlling the operation of a live controller engine. In still even another embodiment, the management console 804 is a power management console 206.

In one embodiment, the management console 804 provides a scheduler interface for managing workload controller schedules. In another embodiment, the management console 804 provides a state management interface for managing and observing the running state of the system. In still another embodiment, the management console 804 provides a configuration interface for changing system-wide configuration settings. In yet another embodiment, the management console 804 provides a reporting interface for executing, displaying and printing pre-defined system reports.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of methods and systems for adaptively load balancing user sessions and dynamically managing power modes for a plurality of servers to reduce energy consumption, it will now become apparent to one of skill in the art that other embodiments incorporating the concepts of the disclosure may be used. Therefore, the disclosure should not be limited to certain embodiments, but rather should be limited only by the spirit and scope of the following claims.

We claim:

1. A method for adaptively load balancing user sessions to reduce energy consumption, comprising:
(a) identifying a session type for each of a plurality of user sessions;
(b) defining a server group providing access to a subset of the plurality of user sessions having a common session type;
(c) defining a power management schedule for the server group; and
(d) consolidating, onto at least one server in the server group, the subset of the plurality of user sessions.

2. The method of claim 1 further comprising receiving, from a power management agent, information identifying a session type for at least one of the plurality of user sessions.

3. The method of claim 1, wherein step (b) further comprises defining a server group including at least one server substantially optimized to provide user sessions of the common session type.

4. The method of claim 1 further comprising monitoring, by a power management agent, a change in a level of load.

5. The method of claim 1 further comprising dynamically modifying the power management schedule for the server group, responsive to a change in a level of load.

6. The method of claim 1 further comprising dynamically allocating an available resource within the server group.

7. The method of claim 1, wherein step (d) further comprises relocating at least one of the subset of the plurality of user sessions from a first server in the server group to a second server in the server group.

8. The method of claim 7 further comprising powering down the first server in the server group.

9. A system for adaptively load balancing user sessions to reduce energy consumption, comprising:
a power management console, providing an interface for:
identifying a session type for each of a plurality of user sessions,
defining a server group providing access to a subset of the plurality of user sessions having a common session type, and
defining a power management schedule for the server group; and
a power management controller consolidating, onto at least one server in the server group, the subset of the plurality of user sessions.

10. The system of claim 9, wherein the power management console further comprises an interface for identifying a level of load associated with the identified session type.

11. The system of claim 9, wherein the power management console further comprises an interface for identifying a session type for an application session.

12. The system of claim 9, wherein the power management console further comprises an interface for identifying a session type for a desktop session.

13. The system of claim 9, wherein the power management console further comprises an interface for identifying a session type for a connection to a virtual machine.

14. The system of claim 9, wherein the power management console further comprises an interface for defining a server group including at least one server substantially optimized to provide user sessions of a common session type.

15. The system of claim 9 further comprising a power monitoring agent, in communication with the power management console and the power management controller, providing information for identifying a session type for at least one of the plurality of user sessions, and monitoring a change in a level of load.

16. The system of claim 9, wherein the power management console automatically defines the power management schedule for the server group, responsive to identifying a session type for each of the plurality of user sessions.

17. The system of claim 9, wherein the power management console automatically defines the power management schedule for the server group, responsive to defining the server group providing access to the subset of the plurality of user sessions having a common session type.

18. The system of claim 9, wherein the power management console dynamically changes the power management schedule for the server group, responsive to a change in a level of load on at least one server in the server group.

19. The system of claim 9, wherein the power management controller dynamically changes the power management schedule for the server group, responsive to a change in a level of load on at least one server in the server group.

20. The system of claim 9, wherein the power management controller further comprises means for dynamically allocating an available resource within the server group.

21. The system of claim 9, wherein the power management controller further comprises means for relocating at least one of the subset of the plurality of user sessions from a first server in the server group to a second server in the server group.

22. The system of claim 21, wherein the power management controller further comprises a transmitter sending a command to the power management agent to power down the first server in the server group.

23. The system of claim 21, wherein the power management controller further comprises means for directing the power management agent to place the first server in the server group in a low power state.

24. A method for reducing energy consumption by dynamically managing power modes for a plurality of servers, comprising:
(a) monitoring, via a power monitoring agent, a level of load on one of a plurality of servers;
(b) generating, by a power management console, a power management schedule for a server in the plurality of servers, responsive to the monitored level of load; and
(c) dynamically controlling, by a power management controller, a level of power for the server, responsive to the power management schedule.

25. The method of claim 24, wherein (b) further comprises dynamically generating, by the power management console, the power management schedule for a server in the plurality of servers, responsive to the monitored level of load.

26. The method of claim 24 further comprising dynamically modifying, by the power management controller, the power management schedule for a server in the plurality of servers, responsive to the monitored level of load.

27. The method of claim 24, wherein (c) further comprises dynamically controlling a level of power by powering up one of a plurality of servers.

28. The method of claim 24, wherein (c) further comprises dynamically controlling a level of power by powering down one of a plurality of servers.

29. A system for reducing energy consumption by dynamically managing power modes for a plurality of servers, comprising:
a power management agent monitoring a level of load on one of the plurality of servers;
a power management console, in communication with the power management agent, defining a power management schedule for the one of the plurality of servers, the power management schedule generated responsive to the monitored level of load; and
a power management controller, in communication with the power management console and the power management agent, dynamically controlling a level of power to the one of the plurality of servers, responsive to the power management schedule.

30. The system of claim 29, wherein the power management agent executes on one of the plurality of servers.

31. The system of claim 29, wherein the power management console further comprises an interface displaying the monitored level of load on one of the plurality of servers.

32. The system of claim 29, wherein the power management console further comprises an interface receiving, from a user, a power management schedule.

33. The system of claim 29, wherein by the power management console further comprises means for dynamically generating the power management schedule for the one of the plurality of servers, responsive to the monitored level of load.

34. The system of claim 29, wherein the power management controller further comprises means for dynamically modifying the power management schedule for the one of the plurality of servers, responsive to the monitored level of load.

35. The system of claim 29, wherein the power management controller further comprises means for controlling one of a plurality of levels of power for the one of the plurality of servers, the plurality of levels of power including a powered-down level.

36. The system of claim 29, wherein the power management controller further comprises means for controlling one of a plurality of levels of power for the one of the plurality of servers, the plurality of levels of power including a low-power level.

37. The system of claim 29, wherein the power management controller further comprises means for controlling one of a plurality of levels of power for the one of the plurality of servers, the plurality of levels of power including an intermediate-power level.

38. The system of claim 29, wherein the power management controller further comprises means for controlling one of a plurality of levels of power for the one of the plurality of servers, the plurality of levels of power including a high-power level.
